(19) United States
(12) Patent Application Publication
(10) Pub. No.: US 2015/0203742 A1
(43) Pub. Date: Jul. 23, 2015

(54) SALT-TOLERANT FRICTION-REDUCING COMPOSITION FOR TREATMENT OF A SUBTERRANEAN FORMATION

(71) Applicant: Halliburton Energy Services, Inc., Houston, TX (US)

(72) Inventors: Baireddy Raghava Reddy, The Woodlands, TX (US); Feng Liang, Cypress, TX (US); Xiangnan Ye, Cypress, TX (US)

(73) Assignee: Halliburton Energy Services, Inc., Houston, TX (US)

(21) Appl. No.: 14/161,490

(22) Filed: Jan. 22, 2014

(51) Int. Cl. C09K 8/588; E21B 43/25

(52) U.S. Cl. CPC C09K 8/588; E21B 43/25

(57) ABSTRACT

Various embodiments disclosed related to a composition for treating a subterranean formation, and methods and systems including the same. In various embodiments, the present invention provides a method of treating a subterranean formation that can include obtaining or providing an aqueous composition including a friction-reducing water-soluble polymer including about Z¹ mol % of an ethylene repeating unit including a —C(O)NHR¹ group and including about N¹ mol % of an ethylene repeating unit comprising a —C(O)R² group. At each occurrence R¹ can independently be a substituted or unsubstituted C₅-C₅₀ hydrocarbyl. At each occurrence R² can independently be selected from the group consisting of —NH₂ and —OR³, wherein at each occurrence R³ is independently selected from the group consisting of —R¹, —H, and a counterion. The repeating units can be in block, alternate, or random configuration. The variable Z¹ can be about 0.001% to about 50%, N¹ can be about 50% to about 99.999%, and Z¹+N¹ can be about 100%. The method also includes placing the composition in a subterranean formation downhole.

### BACKGROUND OF THE INVENTION

Fluid-friction reducers are chemical additives that alter fluid rheological properties to reduce friction created within a fluid as it flows through tubulars or other flowpaths. Generally, polymer-based fluid-friction reducers reduce or delay induced turbulence during flow and thereby reduce friction forces within the wellbore. At low concentrations, polymer-based fluid-friction reducers do not significantly increase the viscosity of an aqueous fluid. Most polymer-based friction reducers are ionic, such as partially hydrolyzed polyacrylamide, are salt intolerant, and lose effectiveness in salt water (e.g., NaCl or KCl).

### SUMMARY OF THE INVENTION

In various embodiments, the present invention provides a method of treating a subterranean formation. The method includes obtaining or providing an aqueous composition including a friction-reducing water-soluble polymer. The polymer includes about Z¹ mol % of an ethylene repeating unit including a —C(O)NHR¹ group. The polymer also includes about N¹ mol % of an ethylene repeating unit including a —C(O)R² group. At each occurrence, R¹ is independently a substituted or unsubstituted C₅-C₅₀ hydrocarbyl. At each occurrence, R² is independently selected from the group consisting of —NH₂ and —OR³. At each occurrence, R³ is independently selected from the group consisting of —R¹, —H, and a counterion. The repeating units are in block, alternate, or random configuration. The variable Z¹ is about 0.001% to about 50%, N¹ is about 50% to about 99.999%, and Z¹+N¹ is about 100%. The method also includes placing the composition in a subterranean formation downhole.

In various embodiments, the present invention provides a method of treating a subterranean formation. The method includes obtaining or providing a composition including a friction-reducing polymer that has repeating units having the structure

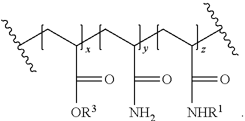

At each occurrence, R¹ is independently C₅-C₅₀ alkyl. At each occurrence, R² is independently selected from the group consisting of —NH₂ and —OR³, wherein at each occurrence, R³ is independently selected from the group consisting of —H and a counterion selected from the group consisting of Na⁺, K⁺, Li⁺, NH₄⁺, and Mg²⁺. The repeating units are in a block, alternate, or random configuration, with each repeating unit is independently in the orientation shown or in the opposite orientation. The variable x is about 300 to about 500,000, y is about 1,000 to about 3,500,000, and z is about 100 to about 1,000,000. The method also includes placing the composition in a subterranean formation.

In various embodiments, the present invention provides a system including a composition including a friction-reducing polymer. The polymer includes about Z¹ mol % of an ethylene repeating unit including a —C(O)NHR¹ group. The polymer also includes about N¹ mol % of an ethylene repeating unit including a —C(O)R² group. At each occurrence, R¹ is independently a substituted or unsubstituted C₅-C₅₀ hydrocarbyl. At each occurrence, R² is independently selected from the group consisting of —NH₂ and —OR³. At each occurrence, R³ is independently selected from the group consisting of —R¹, —H, and a counterion. The repeating units are in block, alternate, or random configuration. The variable Z¹ is about 0.001% to about 50%, N¹ is about 50% to about 99.999%, and Z¹+N¹ is about 100%. The system also includes a subterranean formation including the composition therein.

In various embodiments, the present invention provides a composition for treatment of a subterranean formation. The composition includes a friction-reducing polymer. The polymer includes about Z¹ mol % of an ethylene repeating unit including a —C(O)NHR¹ group. The polymer also includes about N¹ mol % of an ethylene repeating unit including a —C(O)R² group. At each occurrence, R¹ is independently a substituted or unsubstituted C₅-C₅₀ hydrocarbyl. At each occurrence, R² is independently selected from the group consisting of —NH₂ and —OR³. At each occurrence, R³ is independently selected from the group consisting of —R¹, —H, and a counterion. The repeating units are in block, alternate, or random configuration, Z¹ is about 0.001% to about 50%, N¹ is about 50% to about 99.999%, and Z¹+N¹ is about 100%.

In various embodiments, the present invention provides a composition for treatment of a subterranean formation. The composition includes a friction-reducing polymer having repeating units with the structure

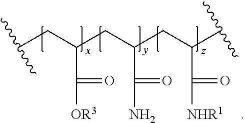

At each occurrence, R¹ is independently C₅-C₅₀ alkyl. At each occurrence, R² is independently selected from the group consisting of —NH₂ and —OR³. At each occurrence, R³ is independently selected from the group consisting of —H and a counterion selected from the group consisting of Na⁺, K⁺, Li⁺, NH₄⁺, and Mg²⁺. The repeating units are in a block, alternate, or random configuration. Each repeating unit is independently in the orientation shown or in the opposite orientation. The variable x is about 300 to about 500,000, y is about 1,000 to about 3,500,000, and z is about 100 to about 1,000,000.

In various embodiments, the present invention provides a method of preparing a composition for treatment of a subterranean formation, the method includes forming a composition including a friction-reducing polymer. The polymer includes about Z¹ mol % of an ethylene repeating unit including a —C(O)NHR¹ group. The polymer also includes about N¹ mol % of an ethylene repeating unit including a —C(O)R² group. At each occurrence, R¹ is independently a substituted or unsubstituted C₅-C₅₀ hydrocarbyl. At each occurrence, R² is independently selected from the group consisting of —NH₂ and —OR³. At each occurrence, R³ is independently selected from the group consisting of —R¹, —H, and a counterion. The repeating units are in block, alternate, or random configuration, Z¹ is about 0.001% to about 50%, N¹ is about 50% to about 99.999%, and Z¹+N¹ is about 100%.

In various embodiments, the present composition and method can have certain advantages over other compositions and methods for reducing friction during treatment of a subterranean formation, at least some of which are unexpected. For example, in some embodiments, a smaller amount of the composition can be effective for friction reduction than would be needed from other friction-reducing compositions to obtain a corresponding reduction in friction. In some embodiments, the composition can be more effective in salt solutions than other compositions. In some embodiments, a smaller amount of the composition can be effective for friction reduction in a salt solution than would be needed from other friction-reducing compositions that are more salt-sensitive to obtain a corresponding reduction in friction. In some embodiments, contrasting with other friction-reducing compositions, the composition can have greater effectiveness in salt solutions than low salinity solutions or aqueous solutions free of salts. In various embodiments, the composition can be less expensive than other salt-tolerant friction reducers such as sulfonate-containing polymers. In various embodiments, the composition can be easier to prepare than other friction reducers, such as via treatment of a polyacrylamide or of a partially hydrolyzed polyacrylamide.

### BRIEF DESCRIPTION OF THE FIGURES

The drawings illustrate generally, by way of example, but not by way of limitation, various embodiments discussed in the present document.

FIG. 1 illustrates a drilling assembly, in accordance with various embodiments.

FIG. 2 illustrates a system or apparatus for delivering a composition downhole, in accordance with various embodiments.

FIG. 3 illustrates the viscosity versus shear rate for a Control Sample and the Samples of Examples 1-4, in accord with various embodiments.

FIG. 4 illustrates percent friction reduction versus time for a Control Sample and the Samples of Examples 1 and 3, in accord with various embodiments.

### DETAILED DESCRIPTION OF THE INVENTION

Reference will now be made in detail to certain embodiments of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

In the methods of manufacturing described herein, the steps can be carried out in any order without departing from the principles of the invention, except when a temporal or operational sequence is explicitly recited. Furthermore, specified steps can be carried out concurrently unless explicit claim language recites that they be carried out separately. For example, a claimed step of doing X and a claimed step of doing Y can be conducted simultaneously within a single operation, and the resulting process will fall within the literal scope of the claimed process.

Selected substituents within the compounds described herein are present to a recursive degree. In this context, “recursive substituent” means that a substituent may recite another instance of itself or of another substituent that itself recites the first substituent. Recursive substituents are an intended aspect of the disclosed subject matter. Because of the recursive nature of such substituents, theoretically, a large number may be present in any given claim. One of ordinary skill in the art of organic chemistry understands that the total number of such substituents is reasonably limited by the desired properties of the compound intended. Such properties include, by way of example and not limitation, physical properties such as molecular weight, solubility, and practical properties such as ease of synthesis. Recursive substituents can call back on themselves any suitable number of times, such as about 1 time, about 2 times, 3, 4, 5, 6, 7, 8, 9, 10, 15, 20, 30, 50, 100, 200, 300, 400, 500, 750, 1000, 1500, 2000, 3000, 4000, 5000, 10,000, 15,000, 20,000, 30,000, 50,000, 100,000, 200,000, 500,000, 750,000, or about 1,000,000 times or more.

The term “about” as used herein can allow for a degree of variability in a value or range, for example, within 10%, within 5%, or within 1% of a stated value or of a stated limit of a range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more.

The term “organic group” as used herein refers to but is not limited to any carbon-containing functional group. For example, an oxygen-containing group such as an alkoxy group, aryloxy group, aralkyloxy group, oxo(carbonyl) group, a carboxyl group including a carboxylic acid, carboxylate, and a carboxylate ester; a sulfur-containing group such as an alkyl and aryl sulfide group; and other heteroatom-containing groups. Non-limiting examples of organic groups include OR, OOR, OC(O)N(R)₂, CN, CF₃, OCF₃, R, C(O), methylenedioxy, ethylenedioxy, N(R)₂, SR, SOR, SO₂R, SO₂N(R)₂, SO₃R, C(O)R, C(O)C(O)R, C(O)CH₂C(O)R, C(S)R, C(O)OR, OC(O)R, C(O)N(R)₂, OC(O)N(R)₂, C(S)N(R)₂, (CH₂)₀₋₂N(R)C(O)R, (CH₂)₀₋₂N(R)N(R)₂, N(R)N(R)C(O)R, N(R)N(R)C(O)OR, N(R)N(R)CON(R)₂, N(R)SO₂R, N(R)SO₂N(R)₂, N(R)C(O)OR, N(R)C(O)R, N(R)C(S)R, N(R)C(O)N(R)₂, N(R)C(S)N(R)₂, N(COR)COR, N(OR)R, C(═NH)N(R)₂, C(O)N(OR)R, or C(═NOR)R wherein R can be hydrogen (in examples that include other carbon atoms) or a carbon-based moiety, and wherein the carbon-based moiety can itself be further substituted.

The term “substituted” as used herein refers to an organic group as defined herein or molecule in which one or more hydrogen atoms contained therein are replaced by one or more non-hydrogen atoms. The term “functional group” or “substituent” as used herein refers to a group that can be or is substituted onto a molecule or onto an organic group. Examples of substituents or functional groups include, but are not limited to, a halogen (e.g., F, Cl, Br, and I); an oxygen atom in groups such as hydroxyl groups, alkoxy groups, aryloxy groups, aralkyloxy groups, oxo(carbonyl) groups, carboxyl groups including carboxylic acids, carboxylates, and carboxylate esters; a sulfur atom in groups such as thiol groups, alkyl and aryl sulfide groups, sulfoxide groups, sulfone groups, sulfonyl groups, and sulfonamide groups; a nitrogen atom in groups such as amines, hydroxylamines, nitriles, nitro groups, N-oxides, hydrazides, azides, and enamines; and other heteroatoms in various other groups. Non-limiting examples of substituents J that can be bonded to a substituted carbon (or other) atom include F, Cl, Br, I, OR, OC(O)N(R¹)₂, CN, NO, NO₂, ONO₂, azido, CF₃, OCF₃, R¹, O (oxo), S (thiono), C(O), S(O), methylenedioxy, ethylenedioxy, N(R)₂, SR, SOR, SO₂R¹, SO₂N(R)₂, SO₃R, C(O)R, C(O)C(O)R, C(O)CH₂C(O)R, C(S)R, C(O)OR, OC(O)R, C(O)N(R)₂, OC(O)N(R)₂, C(S)N(R)₂, (CH₂)₀₋₂, N(R)C(O)R, (CH₂)₀₋₂N(R)N(R)₂, N(R)N(R)C(O)R, N(R)N(R)C(O)OR, N(R)N(R)CON(R)₂, N(R)SO₂R, N(R)SO₂N(R)₂, N(R)C(O)OR, N(R)C(O)R, N(R)C(S)R, N(R)C(O)N(R)₂, N(R)C(S)N(R)₂, N(COR)COR, N(OR)R, C(═NH)N(R)₂, C(O)N(OR)R, or C(═NOR)R wherein R can be hydrogen or a carbon-based moiety, and wherein the carbon-based moiety can itself be further substituted; for example, wherein R can be hydrogen, alkyl, acyl, cycloalkyl, aryl, aralkyl, heterocyclyl, heteroaryl, or heteroarylalkyl, wherein any alkyl, acyl, cycloalkyl, aryl, aralkyl, heterocyclyl, heteroaryl, or heteroarylalkyl or R can be independently mono- or multi-substituted with J; or wherein two R groups bonded to a nitrogen atom or to adjacent nitrogen atoms can together with the nitrogen atom or atoms form a heterocyclyl, which can be mono- or independently multi-substituted with J.

The term “alkyl” as used herein refers to straight chain and branched alkyl groups and cycloalkyl groups having from 1 to 40 carbon atoms, 1 to about 20 carbon atoms, 1 to 12 carbons or, in some embodiments, from 1 to 8 carbon atoms. Examples of straight chain alkyl groups include those with from 1 to 8 carbon atoms such as methyl, ethyl, n-propyl, n-butyl, n-pentyl, n-hexyl, n-heptyl, and n-octyl groups. Examples of branched alkyl groups include, but are not limited to, isopropyl, iso-butyl, sec-butyl, t-butyl, neopentyl, isopentyl, and 2,2-dimethylpropyl groups. As used herein, the term “alkyl” encompasses n-alkyl, isoalkyl, and anteisoalkyl groups as well as other branched chain forms of alkyl. Representative substituted alkyl groups can be substituted one or more times with any of the groups listed herein, for example, amino, hydroxy, cyano, carboxy, nitro, thio, alkoxy, and halogen groups.

The term “alkenyl” as used herein refers to straight and branched chain and cyclic alkyl groups as defined herein, except that at least one double bond exists between two carbon atoms. Thus, alkenyl groups have from 2 to 40 carbon atoms, or 2 to about 20 carbon atoms, or 2 to 12 carbons or, in some embodiments, from 2 to 8 carbon atoms. Examples include, but are not limited to vinyl, —CH═CH(CH₃), —CH═C(CH₃)₂, —C(CH₃)═CH₂, —C(CH₃)═CH(CH₃), —C(CH₂CH₃)═CH₂, cyclohexenyl, cyclopentenyl, cyclohexadienyl, butadienyl, pentadienyl, and hexadienyl among others.

The term “alkynyl” as used herein refers to straight and branched chain alkyl groups, except that at least one triple bond exists between two carbon atoms. Thus, alkynyl groups have from 2 to 40 carbon atoms, 2 to about 20 carbon atoms, or from 2 to 12 carbons or, in some embodiments, from 2 to 8 carbon atoms. Examples include, but are not limited to —C≡CH, —C≡C(CH₃), —C≡C(CH₂CH₃), —CH₂C≡CH, —CH₂C≡C(CH₃), and —CH₂C≡C(CH₂CH₃) among others.

The term “acyl” as used herein refers to a group containing a carbonyl moiety wherein the group is bonded via the carbonyl carbon atom. The carbonyl carbon atom is also bonded to another carbon atom, which can be part of an alkyl, aryl, aralkyl cycloalkyl, cycloalkylalkyl, heterocyclyl, heterocyclylalkyl, heteroaryl, heteroarylalkyl group or the like. In the special case wherein the carbonyl carbon atom is bonded to a hydrogen, the group is a “formyl” group, an acyl group as the term is defined herein. An acyl group can include 0 to about 12-20 or 12-40 additional carbon atoms bonded to the carbonyl group. An acyl group can include double or triple bonds within the meaning herein. An acryloyl group is an example of an acyl group. An acyl group can also include heteroatoms within the meaning here. A nicotinoyl group (pyridyl-3-carbonyl) is an example of an acyl group within the meaning herein. Other examples include acetyl, benzoyl, phenylacetyl, pyridylacetyl, cinnamoyl, and acryloyl groups and the like. When the group containing the carbon atom that is bonded to the carbonyl carbon atom contains a halogen, the group is termed a “haloacyl” group. An example is a trifluoroacetyl group.

The term “cycloalkyl” as used herein refers to cyclic alkyl groups such as, but not limited to, cyclopropyl, cyclobutyl, cyclopentyl, cyclohexyl, cycloheptyl, and cyclooctyl groups. In some embodiments, the cycloalkyl group can have 3 to about 8-12 ring members, whereas in other embodiments the number of ring carbon atoms range from 3 to 4, 5, 6, or 7. Cycloalkyl groups further include polycyclic cycloalkyl groups such as, but not limited to, norbornyl, adamantyl, bornyl, camphenyl, isocamphenyl, and carenyl groups, and fused rings such as, but not limited to, decalinyl, and the like. Cycloalkyl groups also include rings that are substituted with straight or branched chain alkyl groups as defined herein. Representative substituted cycloalkyl groups can be mono-substituted or substituted more than once, such as, but not limited to, 2,2-, 2,3-, 2,4- 2,5- or 2,6-disubstituted cyclohexyl groups or mono-, di- or tri-substituted norbornyl or cycloheptyl groups, which can be substituted with, for example, amino, hydroxy, cyano, carboxy, nitro, thio, alkoxy, and halogen groups. The term “cycloalkenyl” alone or in combination denotes a cyclic alkenyl group.

The term “aryl” as used herein refers to cyclic aromatic hydrocarbons that do not contain heteroatoms in the ring. Thus aryl groups include, but are not limited to, phenyl, azulenyl, heptalenyl, biphenyl, indacenyl, fluorenyl, phenanthrenyl, triphenylenyl, pyrenyl, naphthacenyl, chrysenyl, biphenylenyl, anthracenyl, and naphthyl groups. In some embodiments, aryl groups contain about 6 to about 14 carbons in the ring portions of the groups. Aryl groups can be unsubstituted or substituted, as defined herein. Representative substituted aryl groups can be mono-substituted or substituted more than once, such as, but not limited to, 2-, 3-, 4-, 5-, or 6-substituted phenyl or 2-8 substituted naphthyl groups, which can be substituted with carbon or non-carbon groups such as those listed herein.

The term “heterocyclyl” as used herein refers to aromatic and non-aromatic ring compounds containing 3 or more ring members, of which one or more is a heteroatom such as, but not limited to, N, O, and S. Thus, a heterocyclyl can be a cycloheteroalkyl, or a heteroaryl, or if polycyclic, any combination thereof. In some embodiments, heterocyclyl groups include 3 to about 20 ring members, whereas other such groups have 3 to about 15 ring members. A heterocyclyl group designated as a C₂-heterocyclyl can be a 5-ring with two carbon atoms and three heteroatoms, a 6-ring with two carbon atoms and four heteroatoms and so forth. Likewise a C₄-heterocyclyl can be a 5-ring with one heteroatom, a 6-ring with two heteroatoms, and so forth. The number of carbon atoms plus the number of heteroatoms equals the total number of ring atoms. A heterocyclyl ring can also include one or more double bonds. A heteroaryl ring is an embodiment of a heterocyclyl group. The phrase “heterocyclyl group” includes fused ring species including those that include fused aromatic and non-aromatic groups.

The term “amine” as used herein refers to primary, secondary, and tertiary amines having, e.g., the formula N(group)₃ wherein each group can independently be H or non-H, such as alkyl, aryl, and the like. Amines include but are not limited to R—NH₂, for example, alkylamines, arylamines, alkylarylamines; R₂NH wherein each R is independently selected, such as dialkylamines, diarylamines, aralkylamines, heterocyclylamines and the like; and R₃N wherein each R is independently selected, such as trialkylamines, dialkylarylamines, alkyldiarylamines, triarylamines, and the like. The term “amine” also includes ammonium ions as used herein.

The terms “halo,” “halogen,” or “halide” group, as used herein, by themselves or as part of another substituent, mean, unless otherwise stated, a fluorine, chlorine, bromine, or iodine atom.

The term “haloalkyl” group, as used herein, includes mono-halo alkyl groups, poly-halo alkyl groups wherein all halo atoms can be the same or different, and per-halo alkyl groups, wherein all hydrogen atoms are replaced by halogen atoms, such as fluoro. Examples of haloalkyl include trifluoromethyl, 1,1-dichloroethyl, 1,2-dichloroethyl, 1,3-dibromo-3,3-difluoropropyl, perfluorobutyl, and the like.

The term “hydrocarbon” as used herein refers to a functional group or molecule that includes carbon and hydrogen atoms. The term can also refer to a functional group or molecule that normally includes both carbon and hydrogen atoms but wherein all the hydrogen atoms are substituted with other functional groups.

As used herein, the term “hydrocarbyl” refers to a functional group derived from a straight chain, branched, or cyclic hydrocarbon, and can be alkyl, alkenyl, alkynyl, aryl, cycloalkyl, acyl, or any combination thereof.

The term “solvent” as used herein refers to a liquid that can dissolve a solid, liquid, or gas. Nonlimiting examples of solvents are silicones, organic compounds, water, alcohols, ionic liquids, and supercritical fluids.

The term “number-average molecular weight” as used herein refers to the ordinary arithmetic mean of the molecular weight of individual molecules in a sample. It is defined as the total weight of all molecules in a sample divided by the total number of molecules in the sample. Experimentally, the number-average molecular weight (Mₙ) is determined by analyzing a sample divided into molecular weight fractions of species i having nᵢ molecules of molecular weight Mᵢ through the formula Mₙ=ΣMᵢnᵢ/Σnᵢ. The number-average molecular weight can be measured by a variety of well-known methods including gel permeation chromatography, spectroscopic end group analysis, and osmometry. If unspecified, molecular weights of polymers given herein are number-average molecular weights.

The term “weight-average molecular weight” as used herein refers to M_{w}, which is equal to ΣMᵢ²nᵢ/ΣMᵢnᵢ where nᵢ is the number of molecules of molecular weight Mᵢ. In various examples, the weight-average molecular weight can be determined using light scattering, small angle neutron scattering, X-ray scattering, and sedimentation velocity.

The term “room temperature” as used herein refers to a temperature of about 15° C. to 28° C.

The term “standard temperature and pressure” as used herein refers to 20° C. and 101 kPa.

As used herein, “degree of polymerization” is the number of repeating units in a polymer.

As used herein, the term “polymer” refers to a molecule having at least one repeating unit and can include copolymers.

The term “copolymer” as used herein refers to a polymer that includes at least two different monomers. A copolymer can include any suitable number of monomers.

The term “downhole” as used herein refers to under the surface of the earth, such as a location within or fluidly connected to a wellbore.

As used herein, the term “drilling fluid” refers to fluids, slurries, or muds used in drilling operations downhole, such as during the formation of the wellbore.

As used herein, the term “stimulation fluid” refers to fluids or slurries used downhole during stimulation activities of the well that can increase the production of a well, including perforation activities. In some examples, a stimulation fluid can include a fracturing fluid or an acidizing fluid.

As used herein, the term “clean-up fluid” refers to fluids or slurries used downhole during clean-up activities of the well, such as any treatment to remove material obstructing the flow of desired material from the subterranean formation. In one example, a clean-up fluid can be an acidification treatment to remove material formed by one or more perforation treatments. In another example, a clean-up fluid can be used to remove a filter cake.

As used herein, the term “fracturing fluid” refers to fluids or slurries used downhole during fracturing operations.

As used herein, the term “spotting fluid” refers to fluids or slurries used downhole during spotting operations, and can be any fluid designed for localized treatment of a downhole region. In one example, a spotting fluid can include a lost circulation material for treatment of a specific section of the wellbore, such as to seal off fractures in the wellbore and prevent sag. In another example, a spotting fluid can include a water control material. In some examples, a spotting fluid can be designed to free a stuck piece of drilling or extraction equipment, can reduce torque and drag with drilling lubricants, prevent differential sticking, promote wellbore stability, and can help to control mud weight.

As used herein, the term “completion fluid” refers to fluids or slurries used downhole during the completion phase of a well, including cementing compositions.

As used herein, the term “remedial treatment fluid” refers to fluids or slurries used downhole for remedial treatment of a well. Remedial treatments can include treatments designed to increase or maintain the production rate of a well, such as stimulation or clean-up treatments.

As used herein, the term “acidizing fluid” refers to fluids or slurries used downhole during acidizing treatments. In one example, an acidizing fluid is used in a clean-up operation to remove material obstructing the flow of desired material, such as material formed during a perforation operation. In some examples, an acidizing fluid can be used for damage removal.

As used herein, the term “cementing fluid” refers to fluids or slurries used during cementing operations of a well. For example, a cementing fluid can include an aqueous mixture including at least one of cement and cement kiln dust. In another example, a cementing fluid can include a curable resinous material such as a polymer that is in an at least partially uncured state.

As used herein, the term “water control material” refers to a solid or liquid material that interacts with aqueous material downhole, such that hydrophobic material can more easily travel to the surface and such that hydrophilic material (including water) can less easily travel to the surface. A water control material can be used to treat a well to cause the proportion of water produced to decrease and to cause the proportion of hydrocarbons produced to increase, such as by selectively binding together material between water-producing subterranean formations and the wellbore while still allowing hydrocarbon-producing formations to maintain output.

As used herein, the term “fluid” refers to liquids and gels, unless otherwise indicated.

As used herein, the term “subterranean material” or “subterranean formation” refers to any material under the surface of the earth, including under the surface of the bottom of the ocean. For example, a subterranean formation or material can be any section of a wellbore and any section of a subterranean petroleum- or water-producing formation or region in fluid contact with the wellbore. Placing a material in a subterranean formation can include contacting the material with any section of a wellbore or with any subterranean region in fluid contact therewith. Subterranean materials can include any materials placed into the wellbore such as cement, drill shafts, liners, tubing, or screens; placing a material in a subterranean formation can include contacting with such subterranean materials. In some examples, a subterranean formation or material can be any below-ground region that can produce liquid or gaseous petroleum materials, water, or any section below-ground in fluid contact therewith. For example, a subterranean formation or material can be at least one of an area desired to be fractured, a fracture or an area surrounding a fracture, and a flow pathway or an area surrounding a flow pathway, wherein a fracture or a flow pathway can be optionally fluidly connected to a subterranean petroleum- or water-producing region, directly or through one or more fractures or flow pathways.

As used herein, “treatment of a subterranean formation” can include any activity directed to extraction of water or petroleum materials from a subterranean petroleum- or water-producing formation or region, for example, including drilling, stimulation, hydraulic fracturing, clean-up, acidizing, completion, cementing, remedial treatment, abandonment, and the like.

As used herein, a “flow pathway” downhole can include any suitable subterranean flow pathway through which two subterranean locations are in fluid connection. The flow pathway can be sufficient for petroleum or water to flow from one subterranean location to the wellbore, or vice-versa. A flow pathway can include at least one of a hydraulic fracture, a fluid connection across a screen, across gravel pack, across proppant, including across resin-bonded proppant or proppant deposited in a fracture, and across sand. A flow pathway can include a natural subterranean passageway through which fluids can flow. In some embodiments, a flow pathway can be a water source and can include water. In some embodiments, a flow pathway can be a petroleum source and can include petroleum. In some embodiments, a flow pathway can be sufficient to divert from a wellbore, fracture, or flow pathway connected thereto at least one of water, a downhole fluid, or a produced hydrocarbon.

### Method of Treating a Subterranean Formation.

In some embodiments, the present invention provides a method of treating a subterranean formation. The method includes obtaining or providing a composition including friction-reducing polymer. The obtaining or providing of the composition can occur at any suitable time and at any suitable location. The obtaining or providing of the composition can occur above the surface. The obtaining or providing of the composition can occur downhole. The method also includes placing the composition in a subterranean formation. The placing of the composition in the subterranean formation can include contacting the composition and any suitable part of the subterranean formation, or contacting the composition and a subterranean material downhole, such as any suitable subterranean material. The subterranean formation can be any suitable subterranean formation. In some examples, the placing of the composition in the subterranean formation includes contacting the composition with or placing the composition in at least one of a fracture, at least a part of an area surrounding a fracture, a flow pathway, an area surrounding a flow pathway, and an area desired to be fractured. The placing of the composition in the subterranean formation can be any suitable placing and can include any suitable contacting between the subterranean formation and the composition. The placing of the composition in the subterranean formation can include at least partially depositing the composition in a fracture, flow pathway, or area surrounding the same.

In some embodiments, the placing of the composition in the subterranean formation downhole includes pumping the composition through a tubular disposed in a borehole. In some embodiments, the placing of the composition in the subterranean formation downhole includes pumping the composition through a drill string disposed in a wellbore, through a drill bit at a downhole end of the drill string, and back above-surface through an annulus. In some embodiments, the method can further include processing the composition exiting the annulus with at least one fluid processing unit to generate a cleaned composition and recirculating the cleaned composition through the wellbore.

The composition including the friction reducing compound can be used for any suitable purpose downhole. In some embodiments, the method includes drilling. In some embodiments, the method includes hydraulic fracturing, such as a method of hydraulic fracturing to generate a fracture or flow pathway. The placing of the composition in the subterranean formation or the contacting of the subterranean formation and the hydraulic fracturing can occur at any time with respect to one another; for example, the hydraulic fracturing can occur at least one of before, during, and after the contacting or placing. In some embodiments, the contacting or placing occurs during the hydraulic fracturing, such as during any suitable stage of the hydraulic fracturing, such as during at least one of a pre-pad stage (e.g., during injection of water with no proppant, and additionally optionally mid- to low-strength acid), a pad stage (e.g., during injection of fluid only with no proppant, with some viscosifier, such as to begin to break into an area and initiate fractures to produce sufficient penetration and width to allow proppant-laden later stages to enter), or a slurry stage of the fracturing (e.g., viscous fluid with proppant). The method can include performing a stimulation treatment at least one of before, during, and after placing the composition in the subterranean formation in the fracture, flow pathway, or area surrounding the same. The stimulation treatment can be, for example, at least one of perforating, acidizing, injecting of cleaning fluids, propellant stimulation, and hydraulic fracturing. In some embodiments, the stimulation treatment at least partially generates a fracture or flow pathway where the composition is placed or contacted, or the composition is placed or contacted to an area surrounding the generated fracture or flow pathway.

In various embodiments, the composition includes an oil-external emulsion including the friction-reducing polymer in the internal phase and an oil or organic solvent in the external phase. The oil-external emulsion can include any suitable amount of the polymer. For example, the oil-external emulsion can include about 0.001 wt % to about 75 wt % of the polymer, of about 20 wt % to about 50 wt %, or about 0.001 wt % or less, or about 0.01 wt %, 0.1, 1, 2, 3, 4, 5, 10, 15, 20, 22, 24, 26, 28, 30, 32, 34, 36, 38, 40, 42, 44, 46, 48, 50, 55, 60, 65, 70 wt %, or about 75 wt % or more.

In some embodiments, the method includes mixing the friction-reducing polymer with an aqueous liquid, such as mixing an oil-external emulsion including the friction-reducing polymer with an aqueous liquid. The aqueous liquid can be any suitable aqueous liquid, such as an aqueous downhole fluid, or such as including at least one of water, brine, produced water, flowback water, brackish water, and sea water. The method can include mixing an emulsion inversion aid with the oil-external emulsion and the aqueous liquid. The emulsion invention aid can be any suitable emulsion inversion aid, such as a surfactant, a water-soluble ethoxylated C₁₀-C₁₆ alcohol, a water-miscible solvent, or an aqueous solvent. The mixing of the aqueous liquid and the friction-reducing polymer can occur at any location and at any time, such as above-surface or downhole.

The aqueous liquid can include any suitable amount of salt therein. In some examples, the aqueous liquid includes salt water can having a total dissolved solids level of about 1,000 mg/L to about 250,000 mg/L, or about 10,000 mg/L to about 200,000 mg/L, or about 1,000 mg/L or less, or about 5,000 mg/L, 10,000, 20,000, 25,000, 30,000, 50,000, 75,000, 100,000, 125,000, 150,000, 175,000, 200,000, 225,000, or about 250,000 mg/L or more. The salt can include at least one of NaBr, CaCl₂, CaBr₂, ZnBr₂, NaCl, with each salt independently present at any suitable concentration, such as about 0.000,000,1 g/L to about 250 g/L, or about 10 g/L to about 250 g/L, or about 0.000,000,1 g/L or less, or about 0.000,001 g/L, 0.000,01, 0.000,1, 0.001, 0.01, 0.1, 1, 5, 10, 15, 20, 25, 30, 35, 40, 45, 50, 55, 60, 65, 70, 75, 80, 90, 100, 125, 150, 175, 200, 225, 250, 275 g/L, or about 300 g/L or more. The concentration of Na⁺ ions can be any suitable concentration of Na⁺ ions, such as about 5 ppmw to about 200,000 ppmw, or about 100 ppmw to about 7,000 ppmw, or about 5 ppmw or less, or about 10 ppmw, 50, 100, 500, 1000, 5,000, 10,000, 15,000, 20,000, 50,000, 75,000, 100,000, 150,000, or about 200,000 ppmw or higher. The concentration of Cl⁻ ions can be any suitable concentration of Cl⁻ ions, such as about 10 ppmw to about 400,000 ppmw, about 200 ppmw to about 14,000 ppmw, or about 10 ppmw or less, or about 20, 50, 100, 200, 500, 1,000, 2,500, 5,000, 7,500, 10,000, 12,500, or about 14,000 ppmw or more. The concentration of K⁺ ions can be any suitable concentration of K⁺ ions, such as about 1 ppmw to about 70,000 ppmw, about 40 ppmw to about 2,500 ppmw, or about 1 ppmw or less, or about 10 ppmw, 20, 50, 100, 200, 500, 1,000, 2,500, 5,000, 10,000, 15,000, 20,000, 25,000, 50,000, or about 70,000 ppmw or more. The concentration of Ca²⁺ ions can be any suitable concentration of Ca²⁺ ions, such as about 1 to about 70,000, or about 40 to about 2,500, or about 1 ppmw or less, or about 10 ppmw, 20, 50, 100, 200, 500, 1,000, 2,500, 5,000, 10,000, 15,000, 20,000, 25,000, 50,000, or about 70,000 ppmw or more. The concentration of Br⁻ ions can be any suitable concentration of Br⁻ ions, such as about 0.1 ppmw to about 12,000 ppmw, about 5 ppmw to about 450 ppmw.

In various embodiments, the composition or mixture can include a proppant, a resin-coated proppant, an encapsulated resin, or a combination thereof. A proppant is a material that keeps an induced hydraulic fracture at least partially open during or after a fracturing treatment. Proppants can be transported downhole to the fracture using fluid, such as fracturing fluid or another fluid. A higher-viscosity fluid can more effectively transport proppants to a desired location in a fracture, especially larger proppants, by more effectively keeping proppants in a suspended state within the fluid. Examples of proppants can include sand, gravel, glass beads, polymer beads, ground products from shells and seeds such as walnut hulls, and manmade materials such as ceramic proppant, bauxite, tetrafluoroethylene materials (e.g., TEFLON™ available from DuPont), fruit pit materials, processed wood, composite particulates prepared from a binder and fine grade particulates such as silica, alumina, fumed silica, carbon black, graphite, mica, titanium dioxide, meta-silicate, calcium silicate, kaolin, talc, zirconia, boron, fly ash, hollow glass microspheres, and solid glass, or mixtures thereof. In some embodiments, proppant can have an average particle size, wherein particle size is the largest dimension of a particle, of about 0.001 mm to about 3 mm, about 0.15 mm to about 2.5 mm, about 0.25 mm to about 0.43 mm, about 0.43 mm to about 0.85 mm, about 0.85 mm to about 1.18 mm, about 1.18 mm to about 1.70 mm, or about 1.70 to about 2.36 mm. In some embodiments, the proppant can have a distribution of particle sizes clustering around multiple averages, such as one, two, three, or four different average particle sizes. The composition or mixture can include any suitable amount of proppant, such as about 0.000,1 wt % to about 99.9 wt %, 0.1 wt % to 50 wt %, about 10 wt % to about 50 wt %, or about 0.000,000,01 wt % or less, or about 0.000,001 wt %, 0.000,1, 0.001, 0.01, 0.1, 1, 2, 3, 4, 5, 10, 15, 20, 30, 40, 50, 60, 70, 80, 85, 90, 91, 92, 93, 94, 95, 96, 97, 98, 99, about 99.9 wt %, or about 99.99 wt % or more.

The friction-reducing polymer can be any suitable wt % of the composition, or of a mixture including the composition. For example, the friction-reducing polymer can be about 0.001 wt % to about 50 wt % of the composition or mixture, or about 0.01 wt % to about 0.5 wt %, or about 0.001 wt % or less, or about 0.005 wt %, 0.01, 0.015, 0.02, 0.025, 0.03, 0.035, 0.04, 0.045, 0.05, 0.06, 0.07, 0.08, 0.09, 0.1, 0.2, 0.3, 0.4, 0.5, 0.6, 0.7, 0.8, 0.9, 1, 2, 3, 4, 5, 10, 15, 20, 25, 30, 35, 40, 45, or about 50% or more of the composition or mixture. In some examples, the friction-reducing polymer can be about 0.001 wt % to about 2 wt % of the water in the composition or mixture, or about 0.01 wt % to about 0.5 wt %, or about 0.001 wt % or less, or about 0.005 wt %, 0.01, 0.015, 0.02, 0.025, 0.03, 0.035, 0.04, 0.045, 0.05, 0.06, 0.07, 0.08, 0.09, 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9, or about 2 wt % or more of the water in the composition or mixture.

### Friction-Reducing Polymer.

The composition includes a friction-reducing polymer. The present invention is not limited to any particular theory of operation. Other aqueous solutions of friction-reducing polymers can experience reduced viscosity with higher salt content. However, in some embodiments, the hydrophobic substituents R¹ in the friction-reducing polymer can experience increased intermolecular interactions in water having increased salt content, causing a corresponding increase in viscosity.

The friction-reducing polymer can include about Z¹ mol % of an ethylene repeating unit including a —C(O)NHR¹ group and can include about N¹ mol % of an ethylene repeating unit including a —C(O)R² group. At each occurrence, R¹ can independently be a substituted or unsubstituted C₅-C₅₀ hydrocarbyl. At each occurrence, R² can independently be selected from the group consisting of —NH₂ and —OR³, wherein at each occurrence, R³ is independently selected from the group consisting of —R¹, —H, and a counterion. The repeating units can be in block, alternate, or random configuration. The variable Z¹ can be about 0.001% to about 50%, N¹ can be about 50% to about 99.999%, and Z¹+N¹ can be about 100%. In some embodiments, the friction-reducing polymer is a terpolymer including about X¹ mol % of an ethylene repeating unit including a —C(O)OR³ group and including about Y¹ mol % of an ethylene repeating unit including a —C(O)NH₂ group, wherein the repeating units are in block, alternate, or random configuration, Z¹ is about 0.001% to about 25%, X¹ is about 5% to about 40%, Y¹ is about 40% to about 95%, and Z¹+X¹+Y¹ is about 100%.

In some embodiments, the friction-reducing polymer includes repeating units having the structure

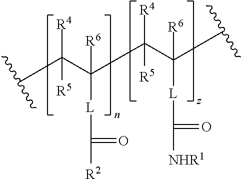

At each occurrence, R⁴, R⁵, and R⁶ can be independently selected from the group consisting of —H and a substituted or unsubstituted C₁-C₅ hydrocarbyl. At each occurrence L can be independently selected from the group consisting of a bond and a substituted or unsubstituted C₁-C₂₀ hydrocarbyl. The repeating units can be in a block, alternate, or random configuration, and each repeating unit is independently in the orientation shown or in the opposite orientation. For example, each monomer repeating unit at each occurrence can independently be stereoregular (e.g., tactic) with respect to adjacent repeating units, or can be stereoirregular (e.g., atactic) with respect to adjacent repeating units. The quantity n/(n+z) can be about 50% to about 99.999%, or about 75% to about 99.9%, or about 50% or less, or about 55%, 60, 65, 70, 75, 80, 85, 90, 95, 96, 97, 98, 99, 99.9, 99.99, or 99.999% or more. The quantity z/(n+z) can be about 0.001% to about 50%, or about 0.1% to about 25%, or about 0.001% or less, or about 0.01%, 0.1, 1, 2, 3, 4, 5, 10, 15, 20, 25, 30, 35, 40, 45, or about 50% or more. The variable n can be about 20,000 to about 2,000,000, or about 5,000 to about 1,700,000, or about 20,000 or less, or about 50,000, 100,000, 200,000, 250,000, 500,000, 750,000, 1,000,000, 1,250,000, 1,500,000, 1,750,000, or about 2,000,000 or more. The variable z can be about 300 to about 1,000,000, or about 500 to about 600,000, or about 300 or less, or about 500, 1,000, 10,000, 20,000, 25,000, 50,000, 100,000, 200,000, 300,000, 400,000, 500,000, 600,000, 700,000, 800,000, 900,000, or about 1,000,000 or more.

In some embodiments, the friction-reducing polymer includes repeating units having the structure

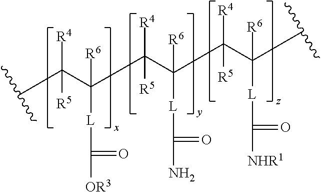

At each occurrence, R⁴, R⁵, and R⁶ can be independently selected from the group consisting of —H and a substituted or unsubstituted C₁-C₅ hydrocarbyl. At each occurrence, L can be independently selected from the group consisting of a bond and a substituted or unsubstituted C₁-C₂₀ hydrocarbyl. The repeating units can be in a block, alternate, or random configuration. Each repeating unit can be independently in the orientation shown or in the opposite orientation, and the quantity x+y=n. The quantity x/(x+y+z) can be about 5% to about 40%, or about 20% to about 30%, or about 5% or less, or about 10%, 15, 20, 25, 30, 35, or about 40% or more. The quantity y/(x+y+z) can be about 40% to about 95%, or about 70% to about 80%, or about 40% or less, or about 45%, 50, 55, 60, 65, 70, 75, 80, 85, 90, or about 95% or more. The quantity z/(x+y+z) can be about 0.001% to about 50%, or about 0.1% to about 25%, or about 0.001% or less, or about 0.01%, 0.1, 1, 2, 3, 4, 5, 10, 15, 20, 25, 30, 35, 40, 45, or about 50% or more. The variable x can be about 300 to about 500,000, or about 1,000 to about 500,000, or about 300 or less, or about 500, 1,000, 5,000, 10,000, 50,000, 100,000, 150,000, 200,000, 250,000, 300,000, 350,000, 400,000, 450,000, or about 500,000 or more. The variable y can be about 1,000 to about 3,500,000, or about 4,000 to about 1,200,000, or about 1,000 or less, or about 5,000, 10,000, 50,000, 100,000, 200,000, 250,000, 500,000, 1,000,000, 1,500,000, 2,000,000, 2,500,000, 3,000,000, or about 3,500,000 or more. The variable z can be about 300 to about 1,000,000, or about 500 to about 600,000, or about 300 or less, or about 500, 1,000, 10,000, 20,000, 25,000, 50,000, 100,000, 200,000, 300,000, 400,000, 500,000, 600,000, 700,000, 800,000, 900,000, or about 1,000,000 or more.

At each occurrence, R⁴, R⁵, and R⁶ can be independently selected from the group consisting of —H and a C₁-C₅ alkyl. At each occurrence, R⁴, R⁵, and R⁶ can be independently selected from the group consisting of —H and a C₁-C₃ alkyl. At each occurrence, R⁴, R⁵, and R⁶ can each be —H.

In some embodiments, at each occurrence, L is independently selected from the group consisting of a bond and C₁-C₂₀ hydrocarbyl. Each L connected directly to the C(O)OR³ group can be a bond (e.g., each C(O)OR³ can be directly bonded to the polymer backbone) and each L connected directly to the C(O)NH₂ or C(O)NHR¹ groups can be independently selected from a bond and C₁-C₂₀ hydrocarbyl. At each occurrence, L can be independently selected from the group consisting of a bond and C₁-C₅ alkyl. In some embodiments, at each occurrence, L can be a bond.

In some embodiments, at each occurrence, R¹ can be independently C₅-C₅₀ hydrocarbyl. At each occurrence, R¹ can be independently C₆-C₂₅ hydrocarbyl. At each occurrence, R¹ can be independently C₁₄-C₁₈ hydrocarbyl. At each occurrence, R¹ can be independently C₆-C₂₅ alkyl.

At each occurrence, R³ can be independently selected from the group consisting of —R¹, —H, and a counterion. The counterion can be any suitable counterion. For example, the counterion can be sodium (Na⁺), potassium (K⁺), lithium (Li⁺), hydrogen (H⁺), zinc (Zn⁺), or ammonium (NH₄⁺). In some embodiments, the counterion can have a positive charge greater than +1, which can, in some embodiments, complex to multiple ionized groups, such as Ca²⁺, Mg²⁺, Zn²⁺ or Al³⁺. For example, the counterion can be selected from the group consisting of Na⁺, K⁺, Li⁺, NH₄⁺, and Mg²⁺. At each occurrence, R³ can be independently selected from the group consisting of —H and a counterion selected from the group consisting of Na⁺, K⁺, Li⁺, NH₄⁺, and Mg²⁺.

The friction-reducing polymer can have any suitable molecular weight. For example, the friction-reducing polymer can have a molecular weight of about 50,000 to about 100,000,000, about 5,000,000 to about 50,000,000, or about 50,000 or less, 100,000, 250,000, 500,000, 1,000,000, 2,500,000, 5,000,000, 10,000,000, 20,000,000, 25,000,000, 50,000,000, 75,000,000, or about 100,000,000 or more.

In some embodiments, the friction-reducing polymer includes repeating units having the structure

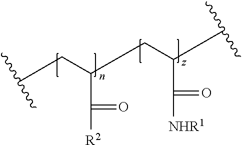

At each occurrence, R¹ can be independently C₅-C₅₀ alkyl. At each occurrence, R² can be independently selected from the group consisting of —NH₂ and —OR³. At each occurrence, R³ can be independently selected from the group consisting of —H and a counterion selected from the group consisting of Na⁺, K⁺, Li⁺, NH₄⁺, and Mg³⁺. The repeating units can be in a block, alternate, or random configuration. Each repeating unit can be independently in the orientation shown or in the opposite orientation. The variable n can be about 20,000 to about 2,000,000 and z can be about 100 to about 1,000,000.

In some embodiments, the friction-reducing polymer can include repeating units having the structure

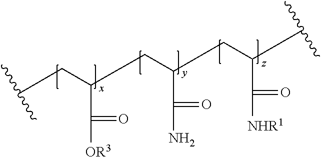

At each occurrence, R¹ can be independently C₅-C₅₀ alkyl. At each occurrence, R² can be independently selected from the group consisting of —NH₂ and —OR³. At each occurrence, R³ can be independently selected from the group consisting of —H and a counterion selected from the group consisting of Na⁺, K⁺, Li⁺, NH₄⁺, and Mg²⁺. The repeating units can be in a block, alternate, or random configuration. Each repeating unit can be independently in the orientation shown or in the opposite orientation. The variable x can be about 300 to about 500,000, y can be about 1,000 to about 3,500,000, and z can be about 100 to about 1,000,000.

In various embodiments, at a concentration of about 0.64 wt % of the friction-reducing polymer in water, at a shear rate of about 0.1 s⁻¹, at standard temperature and pressure, the friction-reducing polymer can provide a viscosity of about 9,500 cP to about 100,000 cP, or about 9,500 cP to about 20,000 cP, or about 9,500 cP or less, or about 10,000 cP, 12,000, 14,000, 16,000, 18,000, 20,000, 25,000, 30,000, 40,000, 50,000, 60,000, 70,000, 80,000, 90,000, or about 100,000 cP or more.

In some embodiments, at a concentration of about 150 ppmw of the friction-reducing polymer in the salt water, after about 25 minutes of pumping through a pipe having an inside diameter of about 0.5 inches at about 10 gal/min, at standard temperature and pressure, the friction-reducing polymer can provide a friction reduction as compared to friction experienced under corresponding conditions by a corresponding solution not including the friction-reducing polymer, such as a friction reduction of about 57% to about 80%, or about 60% to about 70%, or about 50% or less, or about 55%, 60, 65, 70, 75, or about 80% or more. In some embodiments, at a concentration of about 150 ppmw of the friction-reducing polymer in the salt water, after about 25 minutes of pumping through a pipe having an inside diameter of about 0.5 inches at about 10 gal/min, the friction-reducing polymer can provide a friction reduction as compared to that experienced under corresponding conditions by a corresponding solution not including the friction-reducing polymer that is greater as compared to the friction reduction experienced by the salt water under corresponding conditions but having in place of the friction-reducing polymer a corresponding polymer having —C(O)NH₂ groups in place of the —C(O)NHR¹ groups, such as about 1% to about 70% greater, or about 20% to about 50% greater, or about 1% greater or less, or about 2%, 3, 4, 5, 10, 15, 20, 25, 30, 35, 40, 45, 50, 55, 60, 65, or about 70% greater or more.

### Other Components.

The composition can include the friction-reducing polymer neat, or can include one or more suitable additional components in addition to the friction-reducing polymer. The additional components can be any suitable additional components.

In some embodiments, the composition further includes a fluid including at least one of an organic solvent and an oil. The composition can further include a fluid including at least one of dipropylene glycol methyl ether, dipropylene glycol dimethyl ether, dimethyl formamide, diethylene glycol methyl ether, ethylene glycol butyl ether, diethylene glycol butyl ether, propylene carbonate, D-limonene, a C₂-C₄₀ fatty acid C₁-C₁₀ alkyl ester, 2-butoxy ethanol, butyl acetate, furfuryl acetate, dimethyl sulfoxide, dimethyl formamide, diesel, kerosene, mineral oil, a hydrocarbon including an internal olefin, a hydrocarbon including an alpha olefin, xylenes, an ionic liquid, methyl ethyl ketone, and cyclohexanone. The composition can further include at least one of water, brine, produced water, flowback water, brackish water, and sea water.

In some embodiments, the composition can further include a viscosifier. The viscosifier can be any suitable viscosifier. The viscosifier can include at least one of a substituted or unsubstituted polysaccharide, and a substituted or unsubstituted polyalkenylene, wherein the polysaccharide or polyalkenylene is crosslinked or uncrosslinked. The polyalkenylene viscosifier can include at least one monomer selected from the group consisting of ethylene glycol, acrylamide, vinyl acetate, 2-acrylamidomethylpropane sulfonic acid or its salts, trimethylammoniumethyl acrylate halide, and trimethylammoniumethyl methacrylate halide. In some embodiments, the viscosifier can include a crosslinked gel or a crosslinkable gel.

The viscosifier can affect the viscosity of the composition at any suitable time and location. In some embodiments, the viscosifier provides an increased viscosity at least one of before placement in the subterranean formation, at the time of placement into the subterranean formation, during travel downhole, once the composition reaches a particular downhole location, or some period of time after the composition reaches a particular location downhole. In some embodiments, the viscosifier can provide some or no increased viscosity until the viscosifier reaches a desired location downhole, at which point the viscosifier can provide a small or large increase in viscosity.

In some embodiments, the viscosifier includes at least one of a linear polysaccharide, and poly((C₂-C₁₀)alkenylene), wherein at each occurrence the (C₂-C₁₀)alkenylene is independently substituted or unsubstituted. In some embodiments, the viscosifier can include at least one of poly(acrylic acid) or (C₁-C₅)alkyl esters thereof, poly(methacrylic acid) or (C₁-C₅)alkyl esters thereof, poly(vinyl acetate), poly(vinyl alcohol), poly(ethylene glycol), poly(vinyl pyrrolidone), polyacrylamide, poly (hydroxyethyl methacrylate), alginate, chitosan, curdlan, dextran, emulsan, gellan, glucuronan, N-acetyl-glucosamine, N-acetyl-heparosan, hyaluronic acid, kefiran, lentinan, levan, mauran, pullulan, scleroglucan, schizophyllan, stewartan, succinoglycan, xanthan, welan, derivatized starch, tamarind, tragacanth, guar gum, derivatized guar (e.g., hydroxypropyl guar, carboxy methyl guar, or carboxymethyl hydroxylpropyl guar), gum ghatti, gum arabic, locust bean gum, and derivatized cellulose (e.g., carboxymethyl cellulose, hydroxyethyl cellulose, carboxymethyl hydroxyethyl cellulose, hydroxypropyl cellulose, or methyl hydroxyl ethyl cellulose).

In some embodiments, the viscosifier can include a poly(vinyl alcohol) homopolymer, poly(vinyl alcohol) copolymer, a crosslinked poly(vinyl alcohol) homopolymer, and a crosslinked poly(vinyl alcohol) copolymer. The viscosifier can include a poly(vinyl alcohol) copolymer or a crosslinked poly(vinyl alcohol) copolymer including at least one of a graft, linear, branched, block, and random copolymer of vinyl alcohol and at least one of a substituted or unsubstituted (C₂-C₅₀)hydrocarbyl having at least one aliphatic unsaturated C—C bond therein, and a substituted or unsubstituted (C₂-C₅₀)alkene. The viscosifier can include a poly(vinyl alcohol) copolymer or a crosslinked poly(vinyl alcohol) copolymer including at least one of a graft, linear, branched, block, and random copolymer of vinyl alcohol and at least one of vinyl phosphonic acid, vinylidene diphosphonic acid, substituted or unsubstituted 2-acrylamido-2-methylpropanesulfonic acid, a substituted or unsubstituted (C₁-C₂₀)alkenoic acid, propenoic acid, butenoic acid, pentenoic acid, hexenoic acid, octenoic acid, nonenoic acid, decenoic acid, acrylic acid, methacrylic acid, hydroxypropyl acrylic acid, acrylamide, fumaric acid, methacrylic acid, hydroxypropyl acrylic acid, vinyl phosphonic acid, vinylidene diphosphonic acid, itaconic acid, crotonic acid, mesoconic acid, citraconic acid, styrene sulfonic acid, allyl sulfonic acid, methallyl sulfonic acid, vinyl sulfonic acid, and a substituted or unsubstituted (C₁-C₂₀)alkyl ester thereof. The viscosifier can include a poly(vinyl alcohol) copolymer or a crosslinked poly(vinyl alcohol) copolymer including at least one of a graft, linear, branched, block, and random copolymer of vinyl alcohol and at least one of vinyl acetate, vinyl propanoate, vinyl butanoate, vinyl pentanoate, vinyl hexanoate, vinyl 2-methyl butanoate, vinyl 3-ethylpentanoate, and vinyl 3-ethylhexanoate, maleic anhydride, a substituted or unsubstituted (C₁-C₂₀)alkenoic substituted or unsubstituted (C₁-C₂₀)alkanoic anhydride, a substituted or unsubstituted (C₁-C₂₀)alkenoic substituted or unsubstituted (C₁-C₂₀)alkenoic anhydride, propenoic acid anhydride, butenoic acid anhydride, pentenoic acid anhydride, hexenoic acid anhydride, octenoic acid anhydride, nonenoic acid anhydride, decenoic acid anhydride, acrylic acid anhydride, fumaric acid anhydride, methacrylic acid anhydride, hydroxypropyl acrylic acid anhydride, vinyl phosphonic acid anhydride, vinylidene diphosphonic acid anhydride, itaconic acid anhydride, crotonic acid anhydride, mesoconic acid anhydride, citraconic acid anhydride, styrene sulfonic acid anhydride, allyl sulfonic acid anhydride, methallyl sulfonic acid anhydride, vinyl sulfonic acid anhydride, and an N—(C₁-C₁₀)alkenyl nitrogen containing substituted or unsubstituted (C₁-C₁₀)heterocycle. The viscosifier can include a poly(vinyl alcohol) copolymer or a crosslinked poly(vinyl alcohol) copolymer including at least one of a graft, linear, branched, block, and random copolymer that includes a poly(vinylalcohol)-poly(acrylamide) copolymer, a poly(vinylalcohol)-poly(2-acrylamido-2-methylpropanesulfonic acid) copolymer, or a poly(vinylalcohol)-poly(N-vinylpyrrolidone) copolymer. The viscosifier can include a crosslinked poly(vinyl alcohol) homopolymer or copolymer including a crosslinker including at least one of chromium, aluminum, antimony, zirconium, titanium, calcium, boron, iron, silicon, copper, zinc, magnesium, and an ion thereof. The viscosifier can include a crosslinked poly(vinyl alcohol) homopolymer or copolymer including a crosslinker including at least one of an aldehyde, an aldehyde-forming compound, a carboxylic acid or an ester thereof, a sulfonic acid or an ester thereof, a phosphonic acid or an ester thereof, an acid anhydride, and an epihalohydrin.

The composition can include one or more crosslinkers including at least one of chromium, aluminum, antimony, zirconium, titanium, calcium, boron, iron, silicon, copper, zinc, magnesium, and an ion thereof. The composition can include one or more crosslinkers including at least one of boric acid, borax, a borate, a (C₁-C₃₀)hydrocarbylboronic acid, a (C₁-C₃₀)hydrocarbyl ester of a (C₁-C₃₀)hydrocarbylboronic acid, a (C₁-C₃₀)hydrocarbylboronic acid-modified polyacrylamide, ferric chloride, disodium octaborate tetrahydrate, sodium metaborate, sodium diborate, sodium tetraborate, disodium tetraborate, a pentaborate, ulexite, colemanite, magnesium oxide, zirconium lactate, zirconium triethanol amine, zirconium lactate triethanolamine, zirconium carbonate, zirconium acetylacetonate, zirconium malate, zirconium citrate, zirconium diisopropylamine lactate, zirconium glycolate, zirconium triethanol amine glycolate, and zirconium lactate glycolate, titanium lactate, titanium malate, titanium citrate, titanium ammonium lactate, titanium triethanolamine, titanium acetylacetonate, aluminum lactate, or aluminum citrate.

The composition including the friction-reducing polymer can be combined with any suitable downhole fluid before, during, or after the placement of the composition in the subterranean formation or the contacting of the composition and the subterranean material. In some examples, the composition including the friction-reducing polymer is combined with a downhole fluid above the surface, and then the combined composition is placed in a subterranean formation or contacted with a subterranean material. In another example, the composition including the friction-reducing polymer is injected into a subterranean formation to combine with a downhole fluid, and the combined composition is contacted with a subterranean material or is considered to be placed in the subterranean formation. In various examples, at least one of prior to, during, and after the placement of the composition in the subterranean formation or contacting of the subterranean material and the composition, the composition is used downhole, at least one of alone and in combination with other materials, as a drilling fluid, stimulation fluid, fracturing fluid, spotting fluid, clean-up fluid, completion fluid, remedial treatment fluid, pill, acidizing fluid, cementing fluid, packer fluid, or a combination thereof.

In various embodiments, the method includes combining the composition including the friction-reducing polymer with any suitable downhole fluid, such as an aqueous fluid including a drilling fluid, stimulation fluid, fracturing fluid, spotting fluid, clean-up fluid, completion fluid, remedial treatment fluid, pill, acidizing fluid, cementing fluid, packer fluid, or a combination thereof, to form a composition including the fluid-reducing polymer and the downhole fluid, or to form a mixture of the composition and the downhole fluid. The placement of the composition in the subterranean formation can include contacting the subterranean material and the mixture. The contacting of the subterranean material and the composition can include contacting the subterranean material and the mixture. Any suitable weight percent of the composition or mixture, or of the water in the composition or mixture, can be the downhole fluid, such as about 0.001 wt % to about 50 wt %, about 0.001 wt % to about 2 wt %, about 0.001 wt % to about 0.5 wt %, or about 0.001 wt % or less, or about 0.01 wt %, 0.1, 1, 2, 3, 4, 5, 10, 15, 20, 30, 40 wt %, or about 50 wt % or more of the mixture or composition, or of the water in the composition or mixture.

In some embodiments, the composition can include any suitable amount of any suitable material used in a downhole fluid. For example, the composition can include water, saline, aqueous base, oil, organic solvent, synthetic fluid oil phase, aqueous solution, alcohol or polyol, cellulose, starch, alkalinity control agent, acidity control agent, density control agent, density modifier, emulsifier, dispersant, polymeric stabilizer, crosslinking agent, polyacrylamide, polymer or combination of polymers, antioxidant, heat stabilizer, foam control agent, solvent, diluent, plasticizer, filler or inorganic particle, pigment, dye, precipitating agent, rheology modifier, oil-wetting agent, set retarding additive, surfactant, corrosion inhibitor, gas, weight reducing additive, heavy-weight additive, lost circulation material, filtration control additive, salt, fiber, thixotropic additive, breaker, crosslinker, gas, rheology modifier, curing accelerator, curing retarder, pH modifier, chelating agent, scale inhibitor, enzyme, resin, water control material, polymer, oxidizer, a marker, Portland cement, pozzolana cement, gypsum cement, high alumina content cement, slag cement, silica cement, fly ash, metakaolin, shale, zeolite, a crystalline silica compound, amorphous silica, fibers, a hydratable clay, microspheres, pozzolan lime, or a combination thereof.

A drilling fluid, also known as a drilling mud or simply “mud,” is a specially designed fluid that is circulated through a wellbore as the wellbore is being drilled to facilitate the drilling operation. A drilling fluid can be present in the composition including the friction-reducing polymer, or in a mixture that includes the composition, in any suitable amount, such as about 0.001 wt % to about 50 wt %, 0.001 wt % to about 2 wt %, 0.001 to about 0.5 wt %, or about 0.001 wt % or less, or about 0.01, 0.1, 1, 2, 3, 4, 5, 10, 15, 20, 30, 40 wt %, or about 50 wt % or more of the mixture or composition, or of the water in the mixture or composition. In some examples, the drilling fluid can be water-based. The drilling fluid can carry cuttings up from beneath and around the bit, transport them up the annulus, and allow their separation. Also, a drilling fluid can cool and lubricate the drill head as well as reduce friction between the drill string and the sides of the hole. The drilling fluid aids in support of the drill pipe and drill head, and provides a hydrostatic head to maintain the integrity of the wellbore walls and prevent well blowouts. Specific drilling fluid systems can be selected to optimize a drilling operation in accordance with the characteristics of a particular geological formation. The drilling fluid can be formulated to prevent unwanted influxes of formation fluids from permeable rocks and also to form a thin, low permeability filter cake that temporarily seals pores, other openings, and formations penetrated by the bit. In water-based drilling fluids, solid particles are suspended in a water or brine solution containing other components. Oils or other non-aqueous liquids can be emulsified in the water or brine or at least partially solubilized (for less hydrophobic non-aqueous liquids), but water is the continuous phase.

A water-based drilling fluid in embodiments of the present invention can be any suitable water-based drilling fluid. In various embodiments, the drilling fluid can include at least one of water (fresh or brine), a salt (e.g., calcium chloride, sodium chloride, potassium chloride, magnesium chloride, calcium bromide, sodium bromide, potassium bromide, calcium nitrate, sodium formate, potassium formate, cesium formate), aqueous base (e.g., sodium hydroxide or potassium hydroxide), alcohol or polyol, cellulose, starches, alkalinity control agents, density control agents such as a density modifier (e.g., barium sulfate), surfactants (e.g., betaines, alkali metal alkylene acetates, sultaines, ether carboxylates), emulsifiers, dispersants, polymeric stabilizers, crosslinking agents, polyacrylamides, polymers or combinations of polymers, antioxidants, heat stabilizers, foam control agents, solvents, diluents, plasticizers, filler or inorganic particles (e.g., silica), pigments, dyes, precipitating agents (e.g., silicates or aluminum complexes), and rheology modifiers such as thickeners or viscosifiers (e.g., xanthan gum). Any ingredient listed in this paragraph can be either present or not present in the mixture.

A pill is a relatively small quantity (e.g., less than about 500 bbl, or less than about 200 bbl) of drilling fluid used to accomplish a specific task that the regular drilling fluid cannot perform. For example, a pill can be a high-viscosity pill to, for example, help lift cuttings out of a vertical wellbore. In another example, a pill can be a freshwater pill to, for example, dissolve a salt formation. Another example is a pipe-freeing pill to, for example, destroy filter cake and relieve differential sticking forces. In another example, a pill is a lost circulation material pill to, for example, plug a thief zone. A pill can include any component described herein as a component of a drilling fluid.

A cement fluid can include an aqueous mixture of at least one of cement and cement kiln dust. The composition including the friction-reducing polymer can form a useful combination with cement or cement kiln dust. The cement kiln dust can be any suitable cement kiln dust. Cement kiln dust can be formed during the manufacture of cement and can be partially calcined kiln feed that is removed from the gas stream and collected in a dust collector during a manufacturing process. Cement kiln dust can be advantageously utilized in a cost-effective manner since kiln dust is often regarded as a low value waste product of the cement industry. Some embodiments of the cement fluid can include cement kiln dust but no cement, cement kiln dust and cement, or cement but no cement kiln dust. The cement can be any suitable cement. The cement can be a hydraulic cement. A variety of cements can be utilized in accordance with embodiments of the present invention; for example, those including calcium, aluminum, silicon, oxygen, iron, or sulfur, which can set and harden by reaction with water. Suitable cements can include Portland cements, pozzolana cements, gypsum cements, high alumina content cements, slag cements, silica cements, and combinations thereof. In some embodiments, the Portland cements that are suitable for use in embodiments of the present invention are classified as Classes A, C, H, and G cements according to the American Petroleum Institute, API Specification for Materials and Testing for Well Cements, API Specification 10, Fifth Ed., Jul. 1, 1990. A cement can be generally included in the cementing fluid in an amount sufficient to provide the desired compressive strength, density, or cost. In some embodiments, the hydraulic cement can be present in the cementing fluid in an amount in the range of from 0 wt % to about 100 wt %, 0-95 wt %, 20-95 wt %, or about 50-90 wt %. A cement kiln dust can be present in an amount of at least about 0.01 wt %, or about 5 wt %-80 wt %, or about 10 wt % to about 50 wt %.

Optionally, other additives can be added to a cement or kiln dust-containing composition of embodiments of the present invention as deemed appropriate by one skilled in the art, with the benefit of this disclosure. Any optional ingredient listed in this paragraph can be either present or not present in the composition. For example, the composition can include fly ash, metakaolin, shale, zeolite, set retarding additive, surfactant, a gas, accelerators, weight reducing additives, heavy-weight additives, lost circulation materials, filtration control additives, dispersants, and combinations thereof. In some examples, additives can include crystalline silica compounds, amorphous silica, salts, fibers, hydratable clays, microspheres, pozzolan lime, thixotropic additives, combinations thereof, and the like.

### Drilling Assembly.

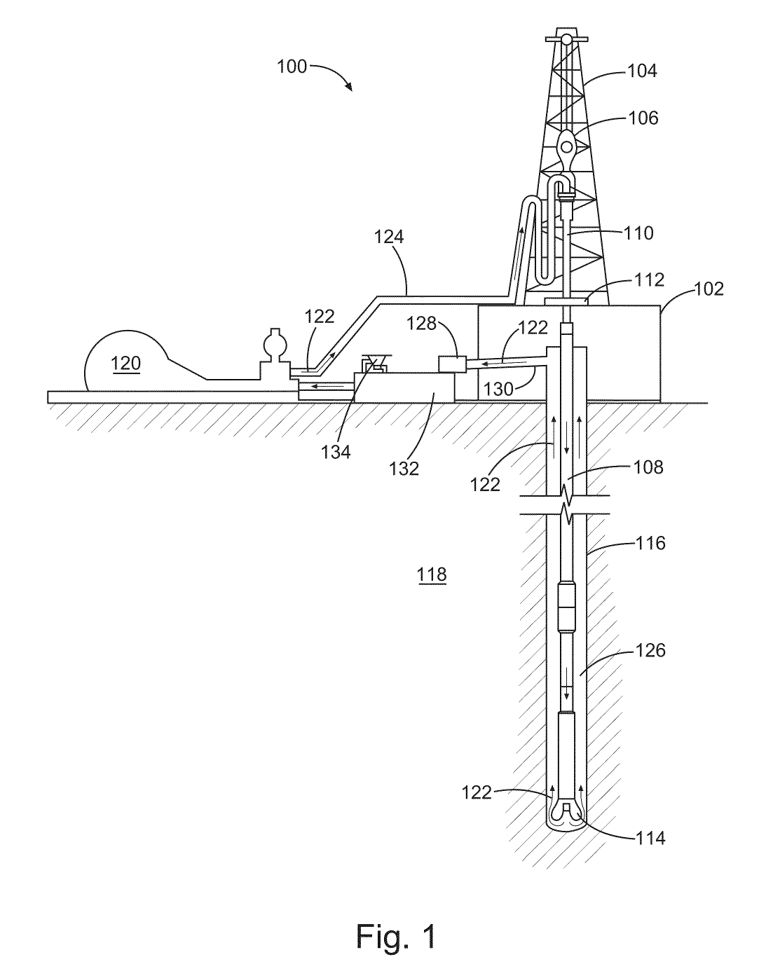

The exemplary composition including the friction-reducing polymer disclosed herein may directly or indirectly affect one or more components or pieces of equipment associated with the preparation, delivery, recapture, recycling, reuse, and/or disposal of the disclosed composition including the friction-reducing polymer. For example, and with reference to FIG. 1, the disclosed composition including the friction-reducing polymer may directly or indirectly affect one or more components or pieces of equipment associated with an exemplary wellbore drilling assembly 100, according to one or more embodiments. It should be noted that while FIG. 1 generally depicts a land-based drilling assembly, those skilled in the art will readily recognize that the principles described herein are equally applicable to subsea drilling operations that employ floating or sea-based platforms and rigs, without departing from the scope of the disclosure.

As illustrated, the drilling assembly 100 may include a drilling platform 102 that supports a derrick 104 having a traveling block 106 for raising and lowering a drill string 108. The drill string 108 may include, but is not limited to, drill pipe and coiled tubing, as generally known to those skilled in the art. A kelly 110 supports the drill string 108 as it is lowered through a rotary table 112. A drill bit 114 is attached to the distal end of the drill string 108 and is driven either by a downhole motor and/or via rotation of the drill string 108 from the well surface. As the bit 114 rotates, it creates a wellbore 116 that penetrates various subterranean formations 118.

A pump 120 (e.g., a mud pump) circulates drilling fluid 122 through a feed pipe 124 and to the kelly 110, which conveys the drilling fluid 122 downhole through the interior of the drill string 108 and through one or more orifices in the drill bit 114. The drilling fluid 122 is then circulated back to the surface via an annulus 126 defined between the drill string 108 and the walls of the wellbore 116. At the surface, the recirculated or spent drilling fluid 122 exits the annulus 126 and may be conveyed to one or more fluid processing unit(s) 128 via an interconnecting flow line 130. After passing through the fluid processing unit(s) 128, a “cleaned” drilling fluid 122 is deposited into a nearby retention pit 132 (e.g., a mud pit). While illustrated as being arranged at the outlet of the wellbore 116 via the annulus 126, those skilled in the art will readily appreciate that the fluid processing unit(s) 128 may be arranged at any other location in the drilling assembly 100 to facilitate its proper function, without departing from the scope of the disclosure.

The composition including the friction-reducing polymer may be added to the drilling fluid 122 via a mixing hopper 134 communicably coupled to or otherwise in fluid communication with the retention pit 132. The mixing hopper 134 may include, but is not limited to, mixers and related mixing equipment known to those skilled in the art. In other embodiments, however, the composition including the friction-reducing polymer may be added to the drilling fluid 122 at any other location in the drilling assembly 100. In at least one embodiment, for example, there could be more than one retention pit 132, such as multiple retention pits 132 in series. Moreover, the retention pit 132 may be representative of one or more fluid storage facilities and/or units where the composition including the friction-reducing polymer may be stored, reconditioned, and/or regulated until added to the drilling fluid 122.

As mentioned above, the composition including the friction-reducing polymer may directly or indirectly affect the components and equipment of the drilling assembly 100. For example, the composition including the friction-reducing polymer may directly or indirectly affect the fluid processing unit(s) 128, which may include, but is not limited to, one or more of a shaker (e.g., shale shaker), a centrifuge, a hydrocyclone, a separator (including magnetic and electrical separators), a desilter, a desander, a separator, a filter (e.g., diatomaceous earth filters), a heat exchanger, or any fluid reclamation equipment. The fluid processing unit(s) 128 may further include one or more sensors, gauges, pumps, compressors, and the like used to store, monitor, regulate, and/or recondition the composition including the friction-reducing polymer.

The composition including the friction-reducing polymer may directly or indirectly affect the pump 120, which representatively includes any conduits, pipelines, trucks, tubulars, and/or pipes used to fluidically convey the composition including the friction-reducing polymer downhole, any pumps, compressors, or motors (e.g., topside or downhole) used to drive the composition into motion, any valves or related joints used to regulate the pressure or flow rate of the composition, and any sensors (e.g., pressure, temperature, flow rate, and the like), gauges, and/or combinations thereof, and the like. The composition including the friction-reducing polymer may also directly or indirectly affect the mixing hopper 134 and the retention pit 132 and their assorted variations.

The composition including the friction-reducing polymer may also directly or indirectly affect the various downhole equipment and tools that may come into contact with the composition including the friction-reducing polymer such as, but not limited to, the drill string 108, any floats, drill collars, mud motors, downhole motors, and/or pumps associated with the drill string 108, and any measurement while drilling (MWD)/logging while drilling (LWD) tools and related telemetry equipment, sensors, or distributed sensors associated with the drill string 108. The composition including the friction-reducing polymer may also directly or indirectly affect any downhole heat exchangers, valves and corresponding actuation devices, tool seals, packers and other wellbore isolation devices or components, and the like associated with the wellbore 116. The composition including the friction-reducing polymer may also directly or indirectly affect the drill bit 114, which may include, but is not limited to, roller cone bits, polycrystalline diamond compact (PDC) bits, natural diamond bits, any hole openers, reamers, coring bits, and the like.

While not specifically illustrated herein, the composition including the friction-reducing polymer may also directly or indirectly affect any transport or delivery equipment used to convey the composition including the friction-reducing polymer to the drilling assembly 100 such as, for example, any transport vessels, conduits, pipelines, trucks, tubulars, and/or pipes used to fluidically move the composition including the friction-reducing polymer from one location to another, any pumps, compressors, or motors used to drive the composition into motion, any valves or related joints used to regulate the pressure or flow rate of the composition, and any sensors (e.g., pressure and temperature), gauges, and/or combinations thereof, and the like.

### System or Apparatus.

In various embodiments, the present invention provides a system. The system can be any suitable system that can use or that can be generated by use of the friction-reducing polymer described herein, or that can perform or be generated by performance of a method for using the friction-reducing polymer described herein. The system can include a composition including the friction-reducing polymer. The system can also include a subterranean formation including the composition therein. In some embodiments, the composition in the system can also include at least one of an aqueous liquid, a downhole fluid, and a proppant.

In some embodiments, the system can include a tubular disposed in a wellbore. The system can include a pump configured to pump the composition downhole through the tubular and into the subterranean formation. In some embodiments, the system can include a subterranean formation including the composition therein.

In some embodiments, the system can include a drillstring disposed in a wellbore. The drillstring can include a drill bit at a downhole end of the drillstring. The system can include an annulus between the drillstring and the wellbore. The system can include a pump configured to circulate the composition through the drill string, through the drill bit, and back above-surface through the annulus. The system can further include a fluid processing unit configured to process the composition exiting the annulus to generate a cleaned drilling fluid for recirculation through the wellbore.

In various embodiments, the present invention provides an apparatus. The apparatus can be any suitable apparatus that can use or that can be generated by use of the friction-reducing polymer described herein in a subterranean formation, or that can perform or be generated by performance of a method for using the method for using the friction-reducing polymer described herein.

Various embodiments provide systems and apparatus configured for delivering the composition described herein to a downhole location and for using the composition therein, such as for hydraulic fracturing or for drilling. In various embodiments, the systems can include a pump fluidly coupled to a tubular (e.g., any suitable type of oilfield pipe, such as pipeline, drill pipe, production tubing, and the like), the tubular containing a composition including the friction-reducing polymer described herein.

The pump can be a high pressure pump in some embodiments. As used herein, the term “high pressure pump” will refer to a pump that is capable of delivering a fluid downhole at a pressure of about 1000 psi or greater. A high pressure pump can be used when it is desired to introduce the composition to a subterranean formation at or above a fracture gradient of the subterranean formation, but it can also be used in cases where fracturing is not desired. In some embodiments, the high pressure pump can be capable of fluidly conveying particulate matter, such as proppant particulates, into the subterranean formation. Suitable high pressure pumps will be known to one having ordinary skill in the art and can include, but are not limited to, floating piston pumps and positive displacement pumps.

In other embodiments, the pump can be a low pressure pump. As used herein, the term “low pressure pump” will refer to a pump that operates at a pressure of about 1000 psi or less. In some embodiments, a low pressure pump can be fluidly coupled to a high pressure pump that is fluidly coupled to the tubular. That is, in such embodiments, the low pressure pump can be configured to convey the composition to the high pressure pump. In such embodiments, the low pressure pump can “step up” the pressure of the composition before it reaches the high pressure pump.

In some embodiments, the systems or apparatuses described herein can further include a mixing tank that is upstream of the pump and in which the composition is formulated. In various embodiments, the pump (e.g., a low pressure pump, a high pressure pump, or a combination thereof) can convey the composition from the mixing tank or other source of the composition to the tubular. In other embodiments, however, the composition can be formulated offsite and transported to a worksite, in which case the composition can be introduced to the tubular via the pump directly from its shipping container (e.g., a truck, a railcar, a barge, or the like) or from a transport pipeline. In either case, the composition can be drawn into the pump, elevated to an appropriate pressure, and then introduced into the tubular for delivery downhole.

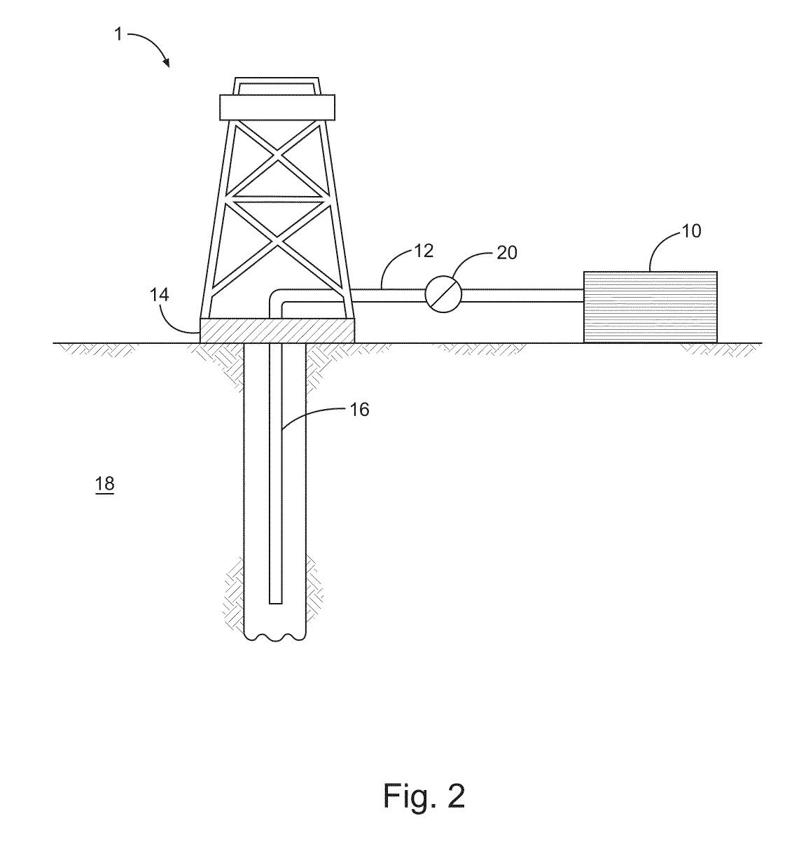

FIG. 2 shows an illustrative schematic of systems and apparatuses that can deliver embodiments of the compositions of the present invention to a downhole location, according to one or more embodiments. It should be noted that while FIG. 2 generally depicts a land-based system or apparatus, it is to be recognized that like systems and apparatuses can be operated in subsea locations as well. Embodiments of the present invention can have a different scale than that depicted in FIG. 2. As depicted in FIG. 2, system or apparatus 1 can include mixing tank 10, in which an embodiment of the composition can be formulated. The composition can be conveyed via line 12 to wellhead 14, where the composition enters tubular 16, with tubular 16 extending from wellhead 14 into subterranean formation 18. Upon being ejected from tubular 16, the composition can subsequently penetrate into subterranean formation 18. Pump 20 can be configured to raise the pressure of the composition to a desired degree before its introduction into tubular 16. It is to be recognized that system or apparatus 1 is merely exemplary in nature and various additional components can be present that have not necessarily been depicted in FIG. 2 in the interest of clarity. Non-limiting additional components that can be present include, but are not limited to, supply hoppers, valves, condensers, adapters, joints, gauges, sensors, compressors, pressure controllers, pressure sensors, flow rate controllers, flow rate sensors, temperature sensors, and the like.

Although not depicted in FIG. 2, at least part of the composition can, in some embodiments, flow back to wellhead 14 and exit subterranean formation 18. The composition that flows back can be substantially diminished in the concentration of the friction-reducing polymer. In some embodiments, the composition that has flowed back to wellhead 14 can subsequently be recovered, and in some examples reformulated, and recirculated to subterranean formation 18.

It is also to be recognized that the disclosed composition can also directly or indirectly affect the various downhole equipment and tools that can come into contact with the composition during operation. Such equipment and tools can include, but are not limited to, wellbore casing, wellbore liner, completion string, insert strings, drill string, coiled tubing, slickline, wireline, drill pipe, drill collars, mud motors, downhole motors and/or pumps, surface-mounted motors and/or pumps, centralizers, turbolizers, scratchers, floats (e.g., shoes, collars, valves, and the like), logging tools and related telemetry equipment, actuators (e.g., electromechanical devices, hydromechanical devices, and the like), sliding sleeves, production sleeves, plugs, screens, filters, flow control devices (e.g., inflow control devices, autonomous inflow control devices, outflow control devices, and the like), couplings (e.g., electro-hydraulic wet connect, dry connect, inductive coupler, and the like), control lines (e.g., electrical, fiber optic, hydraulic, and the like), surveillance lines, drill bits and reamers, sensors or distributed sensors, downhole heat exchangers, valves and corresponding actuation devices, tool seals, packers, cement plugs, bridge plugs, and other wellbore isolation devices or components, and the like. Any of these components can be included in the systems and apparatuses generally described above and depicted in FIG. 2.

### Composition for Treatment of a Subterranean Formation.

Various embodiments provide a composition for treatment of a subterranean formation. The composition can be any suitable composition that can be used to perform an embodiment of the method for treatment of a subterranean formation described herein. For example, the composition can include an embodiment of the friction-reducing polymer described herein.

In some embodiments, the composition further includes a downhole fluid. The downhole fluid can be any suitable downhole fluid. In some embodiments, the downhole fluid is a composition for fracturing of a subterranean formation or subterranean material, or a fracturing fluid. In some embodiments, the composition can include at least one of an aqueous liquid, and a proppant.

### Method for Preparing a Composition for Treatment of a Subterranean Formation.

In various embodiments, the present invention provides a method for preparing a composition for treatment of a subterranean formation. The method can be any suitable method that produces a composition described herein. For example, the method can include forming a composition including an embodiment of the friction-reducing polymer described herein.

In some embodiments, the method can include treating a partially hydrolyzed poly(hydrocarbenylamide), such as a polyacrylamide, with one or more suitable amines under suitable conditions such that trans-amidation occurs and the friction-reducing polymer is generated.

### Examples

Various embodiments of the present invention can be better understood by reference to the following Examples which are offered by way of illustration. The present invention is not limited to the Examples given herein.

The Control Sample is an oil-external emulsion of 26-30 wt % polyacrylamide having 30 mol % hydrolyzed acrylamide units, having a molecular weight of about 10,000,000, with about 65 vol % hydrocarbon external phase and about 35 vol % internal phase. All of the samples synthesized in Examples 1-4 are oil-external emulsions having about 30 wt % polymer, with about 65 vol % hydrocarbon external phase and about 35 vol % internal phase.

### Example 1

### Sample 1—Octadecylamine

In a 100 mL round bottom flask, 30 grams of the Control Sample and 0.21 grams of octadecylamine were added. The mixture was heated at 77° C. for 24 hours, to give Sample 1.

### Example 2

### Sample 2—Octadecylamine

Example 1 was followed, but only 0.105 g of octadecylamine was used, to give Sample 2.

### Example 3

### Sample 3—1-Hexadecylamine

Example 1 was followed, but in place of the octadecylamine, 0.21 g hexadecylamine was used, to give Sample 3.

### Example 4

### Sample 4—1-Dodecylamine

Example 1 was followed, but in place of the octadecylamine, 0.21 g dodecylamine was used, to give Sample 4.

### Example 5

### Viscosity Testing of Samples 1-4

Hydrated samples were prepared by adding 0.15 mL of an invertor surfactant (C₁₂-C₁₄ alcohol ethoxylated with 10-12 mol % of ethylene oxide, in a solvent mixture of water and isopropyl alcohol) to 50 mL Houston tap water followed by adding 1 mL of Control Sample or Samples 1-4. The mixture was sheared at 2000 RPM for 5 min.

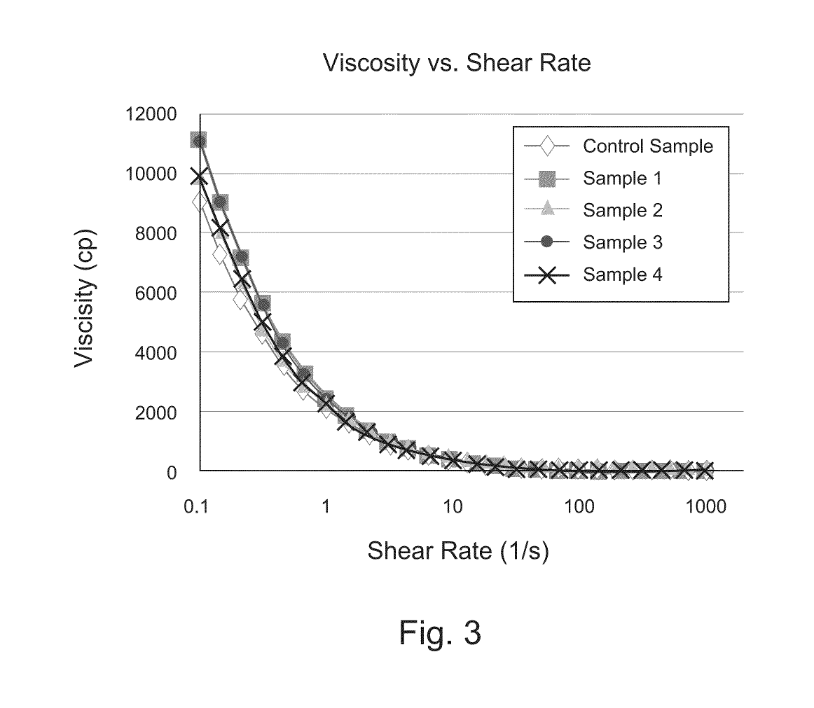

The viscosity/shear rate sweep profiles of the hydrated samples were measured by ARES (TA instruments, New Castle Del., USA) at room temperature. The viscosity versus shear rate of the samples is shown in FIG. 3. The results show that hydrophobically modified Sample 1 (C₁₈ long chain modified) and Sample 3 (C₁₆ long chain modified) have higher viscosity at low shear rate compared to the Control Sample.

### Example 6

### Friction Loop Testing of Samples 1 and 3

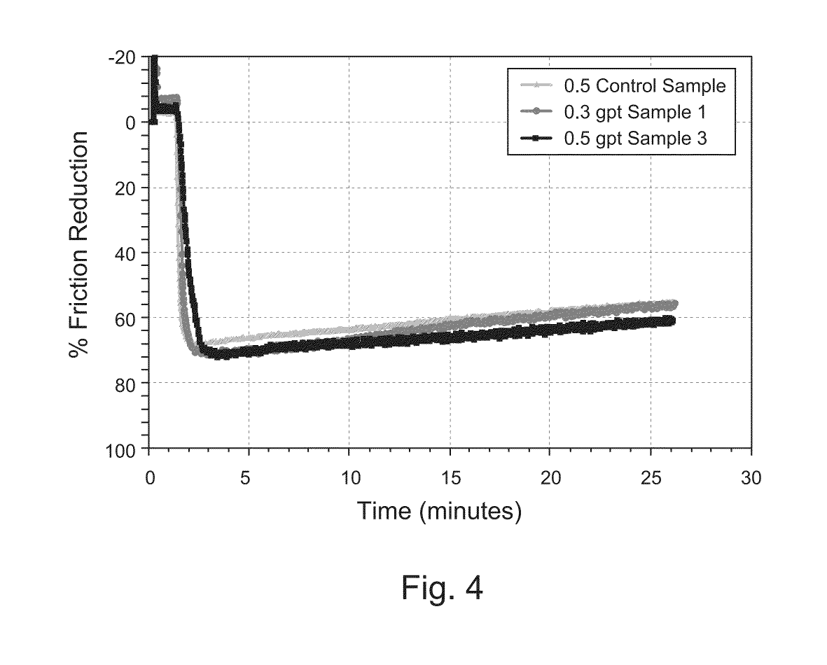

Friction loop testing of Control Sample, Sample 1, and Sample 3 were run in 5% NaCl (50,000 mg/L total dissolved solids (TDS)). The pumping rate for friction loop testing was 10 gal/min through a 0.5 inch pipe. FIG. 4 illustrates the percent friction reduction versus time.

The friction reduction of the Control Sample, at 0.5 gallons per thousand gallons of water (150 ppmw of the friction-reducing polymer), was 67% after hydration in salt water then steadily reduced during shear and finally went down to 56% which might be due to the charged polymer structure shrinkage in salt water or degradation of polymer chain during the shear.

Using the same concentration, 0.5 gpt Sample 3, the friction reduction was 71% after gel hydrated in salt water which is a little higher than the Control Sample. Then the friction reduction only went down to 62% after 25 min of shear. Overall, Sample 3 showed about 5% better friction reduction than the Control Sample, which is estimated to reduce pump pressure by a calculated value of about 900 psi (assuming pumping at 90 barrels per minute (bpm) into 4″ casing and the true vertical depth (TVD) of 10,000 ft).

Sample 1 was tested at 0.3 gpt, which is 60% concentration of the Control Sample at the same pumping rate. The friction reduction was 71% in the salt water, which was the same as 0.5 gpt of Sample 3 and a little higher than 0.5 gpt of the Control Sample. The friction reduction was holding steady, similar to 0.5 gpt of Sample 3 until 10 min of shear time. Then the friction reduction went down to 57% after 25 min of shear time. This indicates that Samples 1 and 3 are more salt tolerant than the Control Sample, and that a given quantity of Sample 1 or 3 can produce a greater friction reduction in salt water than the same quantity of the Control Sample.

The terms and expressions that have been employed are used as terms of description and not of limitation, and there is no intention in the use of such terms and expressions of excluding any equivalents of the features shown and described or portions thereof, but it is recognized that various modifications are possible within the scope of the embodiments of the present invention. Thus, it should be understood that although the present invention has been specifically disclosed by specific embodiments and optional features, modification and variation of the concepts herein disclosed may be resorted to by those of ordinary skill in the art, and that such modifications and variations are considered to be within the scope of embodiments of the present invention.

### Additional Embodiments

The following exemplary embodiments are provided, the numbering of which is not to be construed as designating levels of importance:

Embodiment 1 provides a method of treating a subterranean formation, the method comprising:

obtaining or providing an aqueous composition comprising a friction-reducing water-soluble polymer comprising about Z¹ mol % of an ethylene repeating unit comprising a —C(O)NHR¹ group and comprising about N¹ mol % of an ethylene repeating unit comprising a —C(O)R² group, wherein
at each occurrence R¹ is independently a substituted or unsubstituted C₅-C₅₀ hydrocarbyl,
at each occurrence R² is independently selected from the group consisting of —NH₂ and —OR³, wherein at each occurrence R³ is independently selected from the group consisting of —R¹, —H, and a counterion,
the repeating units are in block, alternate, or random configuration, Z¹ is about 0.001% to about 50%, N¹ is about 50% to about 99.999%, and Z¹+N¹ is about 100%; and

placing the composition in a subterranean formation downhole.

Embodiment 2 provides the method of Embodiment 1, wherein the obtaining or providing of the composition occurs above-surface.

Embodiment 3 provides the method of any one of Embodiments 1-2, wherein the obtaining or providing of the composition occurs downhole.

Embodiment 4 provides the method of any one of Embodiments 1-3, wherein the composition comprises an oil-external emulsion comprising the friction-reducing polymer in the internal phase and an oil or organic solvent in the external phase.

Embodiment 5 provides the method of Embodiment 4, wherein the oil-external emulsion comprises 20 wt % to about 50 wt % of the polymer.

Embodiment 6 provides the method of any one of Embodiments 1-5, wherein the composition comprises an aqueous liquid or wherein a mixture includes the composition and the aqueous liquid.

Embodiment 7 provides the method of Embodiment 6, wherein the method further comprises mixing an aqueous liquid and an oil-external emulsion comprising the friction-reducing polymer.

Embodiment 8 provides the method of any one of Embodiments 6-7, wherein the aqueous liquid comprises at least one of water, brine, produced water, flowback water, brackish water, and sea water.

Embodiment 9 provides the method of any one of Embodiments 7-8, wherein the mixing of the aqueous liquid and the oil-external emulsion further comprises mixing the aqueous liquid and the oil-external emulsion and an emulsion inversion aid.

Embodiment 10 provides the method of Embodiment 9, wherein the emulsion inversion aid comprises a surfactant.

Embodiment 11 provides the method of Embodiment 10, wherein the surfactant comprises a water-soluble ethoxylated C₁₀-C₁₆ alcohol.

Embodiment 12 provides the method of any one of Embodiments 10-11, wherein the surfactant comprises a water-miscible solvent.

Embodiment 13 provides the method of any one of Embodiments 10-12, wherein the surfactant comprises an aqueous solvent.

Embodiment 14 provides the method of any one of Embodiments 7-13, wherein the mixing of the aqueous liquid and the friction-reducing polymer occurs above-surface.

Embodiment 15 provides the method of any one of Embodiments 7-14, wherein the mixing of the aqueous liquid and the friction-reducing polymer occurs downhole.

Embodiment 16 provides the method of any one of Embodiments 6-15, wherein the aqueous liquid comprises at least one of water, salt water, sea water, brackish water, flowback water, and produced water.

Embodiment 17 provides the method of any one of Embodiments 6-16, wherein the aqueous liquid comprises salt water having a total dissolved solids level of about 1,000 mg/L to about 250,000 mg/L.

Embodiment 18 provides the method of Embodiment 17, wherein the salt water has a total dissolved solids level of at least about 25,000 mg/L.

Embodiment 19 provides the method of any one of Embodiments 1-18, wherein the friction-reducing polymer is sufficient such that, at a concentration of the friction-reducing polymer of about 0.64 wt % in water, at a shear rate of about 0.1 s⁻¹, at standard temperature and pressure, a viscosity of about 9,500 cP to about 100,000 cP is provided.

Embodiment 20 provides the method of any one of Embodiments 1-19, wherein at a concentration of the friction-reducing polymer of about 0.64 wt % in water, at a shear rate of about 0.1 s⁻¹, at standard temperature and pressure, a viscosity of about 9,500 cP to about 20,000 cP is provided.

Embodiment 21 provides the method of any one of Embodiments 17-20, wherein the friction-reducing polymer is sufficient such that, at a concentration of the friction-reducing polymer of about 150 ppmw in the salt water, after about 25 minutes of pumping through a pipe having an inside diameter of about 0.5 inches at about 10 gal/min, at standard temperature and pressure, a friction reduction of about 57% to about 80% is provided, as compared to friction experienced under corresponding conditions by a corresponding solution not including the friction-reducing polymer.

Embodiment 22 provides the method of any one of Embodiments 17-21, wherein the friction-reducing polymer is sufficient such that, at a concentration of the friction-reducing polymer of about 150 ppmw in the salt water, after about 25 minutes of pumping through a pipe having an inside diameter of about 0.5 inches at about 10 gal/min, at standard temperature and pressure, a friction reduction of about 60% to about 70% is provided, as compared to friction experienced under corresponding conditions by a corresponding solution not including the friction-reducing polymer.

Embodiment 23 provides the method of any one of Embodiments 17-22, wherein the friction-reducing polymer is sufficient such that, at a concentration of the friction-reducing polymer of about 150 ppmw in the salt water, after about 25 minutes of pumping through a pipe having an inside diameter of about 0.5 inches at about 10 gal/min, a friction reduction is provided, as compared to that experienced under corresponding conditions by a corresponding solution not including the friction-reducing polymer, that is about 1% to about 70% greater as compared to the friction reduction experienced by the salt water under corresponding conditions but having in place of the friction-reducing polymer a corresponding polymer having —C(O)NH₂ groups in place of the —C(O)NHR¹ groups.

Embodiment 24 provides the method of any one of Embodiments 17-23, wherein the friction-reducing polymer is sufficient such that, at a concentration of about 150 ppmw of the friction-reducing polymer in the salt water, after about 25 minutes of pumping through a pipe having an inside diameter of about 0.5 inches at about 10 gal/min, a friction reduction is provided, as compared to that experienced under corresponding conditions by a corresponding solution not including the friction-reducing polymer, that is about 20% to about 50% greater as compared to the friction reduction experienced by the salt water under corresponding conditions but having in place of the friction-reducing polymer a corresponding polymer having —C(O)NH₂ groups in place of the —C(O)NHR¹ groups.

Embodiment 25 provides the method of any one of Embodiments 1-24, wherein the placement of the composition in the subterranean formation comprises fracturing at least part of the subterranean formation to form at least one subterranean fracture.

Embodiment 26 provides the method of any one of Embodiments 1-25, wherein the composition further comprises a proppant, a resin-coated proppant, or a combination thereof.

Embodiment 27 provides the method of Embodiment 26, wherein the proppant comprises sand, gravel, glass beads, polymer beads, a ground products from shells or seeds, ceramic, bauxite, tetrafluoroethylene materials, fruit pit materials, processed wood, silica, alumina, fumed silica, carbon black, graphite, mica, titanium dioxide, meta-silicate, calcium silicate, kaolin, talc, zirconia, boron, fly ash, hollow glass microspheres, solid glass, or mixtures thereof.

Embodiment 28 provides the method of any one of Embodiments 26-27, wherein about 0.001 wt % to about 50 wt % of the composition is the proppant.

Embodiment 29 provides the method of any one of Embodiments 1-28, wherein the friction-reducing polymer is about 0.001 wt % to about 50 wt % of the composition.

Embodiment 30 provides the method of any one of Embodiments 1-29, wherein the friction-reducing polymer is about 0.01 wt % to about 0.5 wt % of the composition.

Embodiment 31 provides the method of any one of Embodiments 1-30, wherein the friction-reducing polymer is a terpolymer comprising about X¹ mol % of an ethylene repeating unit comprising a —C(O)OR³ group and comprising about Y¹ mol % of an ethylene repeating unit comprising a —C(O)NH₂ group, wherein the repeating units are in block, alternate, or random configuration, Z¹ is about 0.001% to about 25%, X¹ is about 5% to about 40%, Y¹ is about 40% to about 95%, and Z¹+X¹+Y¹ is about 100%

Embodiment 32 provides the method of any one of Embodiments 1-31, wherein the friction-reducing polymer comprises repeating units having the structure

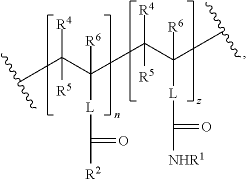

wherein
at each occurrence R⁴, R⁵, and R⁶ are independently selected from the group consisting of —H and a substituted or unsubstituted C₁-C₅ hydrocarbyl,
at each occurrence L is independently selected from the group consisting of a bond and a substituted or unsubstituted C₁-C₂₀ hydrocarbyl,
the repeating units are in a block, alternate, or random configuration, and each repeating unit is independently in the orientation shown or in the opposite orientation.

Embodiment 33 provides the method of Embodiment 32, wherein n/(n+z) is about 75% to about 99.9% and z/(n+z) is about 0.1% to about 25%.

Embodiment 34 provides the method of any one of Embodiments 1-33, wherein the friction-reducing polymer comprises repeating units having the structure

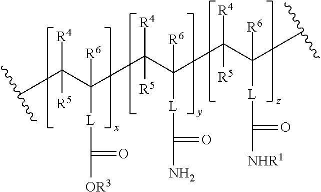

wherein
at each occurrence R⁴, R⁵, and R⁶ are independently selected from the group consisting of —H and a substituted or unsubstituted C₁-C₅ hydrocarbyl,
at each occurrence L is independently selected from the group consisting of a bond and a substituted or unsubstituted C₁-C₂₀ hydrocarbyl,
the repeating units are in a block, alternate, or random configuration, each repeating unit is independently in the orientation shown or in the opposite orientation, and x+y=n.

Embodiment 35 provides the method of Embodiment 34, wherein x/(x+y+z) is about 5% to about 40%, and y/(x+y+z) is about 40% to about 95%.

Embodiment 36 provides the method of any one of Embodiments 34-35, wherein x/(x+y+z) is about 20% to about 30%, and y/(x+y+z) is about 70% to about 80%.

Embodiment 37 provides the method of any one of Embodiments 34-36, wherein at each occurrence R⁴, R⁵, and R⁶ are independently selected from the group consisting of —H and a C₁-C₅ alkyl.

Embodiment 38 provides the method of any one of Embodiments 34-37, wherein at each occurrence R⁴, R⁵, and R⁶ are independently selected from the group consisting of —H and a C₁-C₃ alkyl.

Embodiment 39 provides the method of any one of Embodiments 34-38, wherein at each occurrence R⁴, R⁵, and R⁶ are each —H.

Embodiment 40 provides the method of any one of Embodiments 34-39, wherein at each occurrence L is independently selected from the group consisting of a bond and C₁-C₂₀ hydrocarbyl.

Embodiment 41 provides the method of any one of Embodiments 34-40, wherein at each occurrence L is independently selected from the group consisting of a bond and C₁-C₅ alkyl.

Embodiment 42 provides the method of any one of Embodiments 34-41, wherein each L connected directly to the C(O)OR³ group is a bond and each L connected directly to the C(O)NH₂ or C(O)NHR¹ groups is independently selected from a bond and C₁-C₂₀ hydrocarbyl.

Embodiment 43 provides the method of any one of Embodiments 34-42, wherein at each occurrence L is a bond.

Embodiment 44 provides the method of any one of Embodiments 34-43, wherein at each occurrence R¹ is independently C₅-C₅₀ hydrocarbyl.

Embodiment 45 provides the method of any one of Embodiments 34-44, wherein at each occurrence R¹ is independently C₆-C₂₅ hydrocarbyl.

Embodiment 46 provides the method of any one of Embodiments 34-45, wherein at each occurrence R¹ is independently C₁₄-C₁₈ hydrocarbyl.

Embodiment 47 provides the method of any one of Embodiments 34-46, wherein at each occurrence R¹ is independently C₆-C₂₅ alkyl.

Embodiment 48 provides the method of any one of Embodiments 34-47, wherein at each occurrence R³ is independently selected from the group consisting of —R¹, —H, and a counterion selected from the group consisting of Na⁺, K⁺, Li⁺, NH₄⁺, and Mg²⁺.

Embodiment 49 provides the method of any one of Embodiments 34-48, wherein at each occurrence R³ is independently selected from the group consisting of —H and a counterion selected from the group consisting of Na⁺, K⁺, Li⁺, NH₄⁺, and Mg²⁺.

Embodiment 50 provides the method of any one of Embodiments 32-49, wherein n is about 20,000 to about 2,000,000 and z is about 100 to about 1,000,000.

Embodiment 51 provides the method of any one of Embodiments 32-50, wherein n is about 5,000 to about 1,700,000 and z is about 500 to about 600,000.

Embodiment 52 provides the method of any one of Embodiments 34-51, wherein x is about 300 to about 500,000, y is about 1,000 to about 3,500,000, and z is about 300 to about 1,000,000.

Embodiment 53 provides the method of any one of Embodiments 34-52, wherein x is about 1,000 to about 500,000, y is about 4,000 to about 1,200,000, and z is about 500 to about 600,000.

Embodiment 54 provides the method of any one of Embodiments 1-53, wherein the friction-reducing polymer has a molecular weight of about 50,000 to about 100,000,000.

Embodiment 55 provides the method of any one of Embodiments 1-54, wherein the friction-reducing polymer has a molecular weight of about 5,000,000 to about 50,000,000.

Embodiment 56 provides the method of any one of Embodiments 1-55, wherein the friction-reducing polymer comprises repeating units having the structure

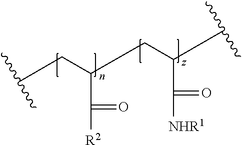

wherein
at each occurrence R¹ is independently C₅-C₅₀ alkyl,
at each occurrence R² is independently selected from the group consisting of —NH₂ and —OR³, wherein at each occurrence R³ is independently selected from the group consisting of —H and a counterion selected from the group consisting of Na⁺, K⁺, Li⁺, NH₄⁺, and Mg²⁺,
the repeating units are in a block, alternate, or random configuration, each repeating unit is independently in the orientation shown or in the opposite orientation, and
n is about 20,000 to about 2,000,000 and z is about 100 to about 1,000,000.

Embodiment 57 provides the method of any one of Embodiments 1-56, wherein the friction-reducing polymer comprises repeating units having the structure

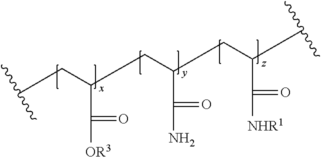

wherein
at each occurrence R¹ is independently C₅-C₅₀ alkyl,
at each occurrence R² is independently selected from the group consisting of —NH₂ and —OR³, wherein at each occurrence R³ is independently selected from the group consisting of —H and a counterion selected from the group consisting of Na⁺, K⁺, Li⁺, NH₄⁺, and Mg²⁺,
the repeating units are in a block, alternate, or random configuration, each repeating unit is independently in the orientation shown or in the opposite orientation, and
x is about 300 to about 500,000, y is about 1,000 to about 3,500,000, and z is about 100 to about 1,000,000.

Embodiment 58 provides the method of any one of Embodiments 1-57, wherein the composition further comprises a fluid comprising at least one of an organic solvent and an oil.

Embodiment 59 provides the method of any one of Embodiments 1-58, wherein the composition further comprises a fluid comprising at least one of dipropylene glycol methyl ether, dipropylene glycol dimethyl ether, dimethyl formamide, diethylene glycol methyl ether, ethylene glycol butyl ether, diethylene glycol butyl ether, propylene carbonate, D-limonene, a C₂-C₄₀ fatty acid C₁-C₁₀ alkyl ester, 2-butoxy ethanol, butyl acetate, furfuryl acetate, dimethyl sulfoxide, dimethyl formamide, diesel, kerosene, mineral oil, a hydrocarbon comprising an internal olefin, a hydrocarbon comprising an alpha olefin, xylenes, an ionic liquid, methyl ethyl ketone, and cyclohexanone.

Embodiment 60 provides the method of any one of Embodiments 1-59, wherein the composition further comprises a viscosifier.

Embodiment 61 provides the method of Embodiment 60, wherein the viscosifier comprises at least one of a substituted or unsubstituted polysaccharide, and a substituted or unsubstituted polyalkenylene, wherein the polysaccharide or polyalkenylene is crosslinked or uncrosslinked.

Embodiment 62 provides the method of any one of Embodiments 60-61, wherein the viscosifier comprises a polymer comprising at least one monomer selected from the group consisting of ethylene glycol, acrylamide, vinyl acetate, 2-acrylamidomethylpropane sulfonic acid or its salts, trimethylammoniumethyl acrylate halide, and trimethylammoniumethyl methacrylate halide.

Embodiment 63 provides the method of any one of Embodiments 60-62, wherein the viscosifier comprises a crosslinked gel or a crosslinkable gel.

Embodiment 64 provides the method of any one of Embodiments 60-63, wherein the viscosifier comprises at least one of a linear polysaccharide, and poly((C₂-C₁₀)alkenylene), wherein the (C₂-C₁₀)alkenylene is substituted or unsubstituted.

Embodiment 65 provides the method of any one of Embodiments 60-64, wherein the viscosifier comprises at least one of poly(acrylic acid) or (C₁-C₅)alkyl esters thereof, poly(methacrylic acid) or (C₁-C₅)alkyl esters thereof, poly(vinyl acetate), poly(vinyl alcohol), poly(ethylene glycol), poly(vinyl pyrrolidone), polyacrylamide, poly (hydroxyethyl methacrylate), alginate, chitosan, curdlan, dextran, emulsan, a galactoglucopolysaccharide, gellan, glucuronan, N-acetyl-glucosamine, N-acetyl-heparosan, hyaluronic acid, kefiran, lentinan, levan, mauran, pullulan, scleroglucan, schizophyllan, stewartan, succinoglycan, xanthan, welan, derivatized starch, tamarind, tragacanth, guar gum, derivatized guar, gum ghatti, gum arabic, locust bean gum, derivatized cellulose, carboxymethyl cellulose, hydroxyethyl cellulose, carboxymethyl hydroxyethyl cellulose, hydroxypropyl cellulose, methyl hydroxyl ethyl cellulose, guar, hydroxypropyl guar, carboxy methyl guar, and carboxymethyl hydroxylpropyl guar.

Embodiment 66 provides the method of any one of Embodiments 60-65, wherein the viscosifier comprises poly(vinyl alcohol) homopolymer, poly(vinyl alcohol) copolymer, a crosslinked poly(vinyl alcohol) homopolymer, and a crosslinked poly(vinyl alcohol) copolymer.

Embodiment 67 provides the method of any one of Embodiments 1-66, wherein the composition further comprises an aqueous or oil-based fluid comprising a drilling fluid, stimulation fluid, fracturing fluid, spotting fluid, clean-up fluid, completion fluid, remedial treatment fluid, pill, acidizing fluid, cementing fluid, packer fluid, or a combination thereof.

Embodiment 68 provides the method of Embodiment 67, wherein the cementing fluid comprises Portland cement, pozzolana cement, gypsum cement, high alumina content cement, slag cement, silica cement, or a combination thereof.

Embodiment 69 provides the method of any one of Embodiments 1-68, wherein at least one of prior to, during, and after the placing of the composition in the subterranean formation, the composition is used downhole, at least one of alone and in combination with other materials, as a drilling fluid, stimulation fluid, fracturing fluid, spotting fluid, clean-up fluid, completion fluid, remedial treatment fluid, pill, acidizing fluid, cementing fluid, packer fluid, or a combination thereof.

Embodiment 70 provides the method of any one of Embodiments 1-69, wherein the placing of the composition in the subterranean formation downhole comprises pumping the composition through a drill string disposed in a wellbore, through a drill bit at a downhole end of the drill string, and back above-surface through an annulus.

Embodiment 71 provides the method of Embodiment 70, further comprising processing the composition exiting the annulus with at least one fluid processing unit to generate a cleaned composition and recirculating the cleaned composition through the wellbore.

Embodiment 72 provides a system for performing the method of any one of Embodiments 1-71, the system comprising: a tubular disposed in a wellbore; a pump configured to pump the composition downhole through the tubular and into the subterranean formation.

Embodiment 73 provides a system generated by the method of any one of Embodiments 1-72, the system comprising: a subterranean formation comprising the composition therein.

Embodiment 74 provides a method of treating a subterranean formation, the method comprising:

obtaining or providing a composition comprising a friction-reducing polymer comprises repeating units having the structure

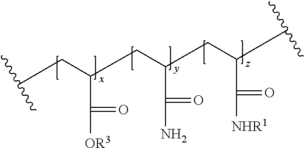

wherein
at each occurrence R¹ is independently C₅-C₅₀ alkyl;
at each occurrence R² is independently selected from the group consisting of —NH₂ and —OR³, wherein at each occurrence R³ is independently selected from the group consisting of —H and a counterion selected from the group consisting of Na⁺, K⁺, Li⁺, NH₄⁺, and Mg²⁺,
the repeating units are in a block, alternate, or random configuration, each repeating unit is independently in the orientation shown or in the opposite orientation, and
x is about 300 to about 500,000, y is about 1,000 to about 3,500,000, and z is about 100 to about 1,000,000; and placing the composition in a subterranean formation.

Embodiment 75 provides the method of Embodiment 74, wherein the composition further comprises an aqueous liquid.

Embodiment 76 provides the method of Embodiment 75, wherein the aqueous liquid is salt water having a total dissolved solids level of about 1,000 mg/L to about 250,000 mg/L.

Embodiment 77 provides a system comprising:

a composition comprising a friction-reducing polymer comprising about Z¹ mol % of an ethylene repeating unit comprising a —C(O)NHR¹ group and comprising about N¹ mol % of an ethylene repeating unit comprising a —C(O)R² group, wherein
at each occurrence R¹ is independently a substituted or unsubstituted C₅-C₅₀ hydrocarbyl;
at each occurrence R² is independently selected from the group consisting of —NH₂ and —OR³, wherein at each occurrence R³ is independently selected from the group consisting of —R¹, —H, and a counterion; and
the repeating units are in block, alternate, or random configuration, Z¹ is about 0.001% to about 50%, N¹ is about 50% to about 99.999%, and Z¹+N¹ is about 100%; and

a subterranean formation comprising the composition therein.

Embodiment 78 provides the system of Embodiment 77, further comprising a drillstring disposed in a wellbore, the drillstring comprising a drill bit at a downhole end of the drillstring; an annulus between the drillstring and the wellbore; and a pump configured to circulate the composition through the drill string, through the drill bit, and back above-surface through the annulus.

Embodiment 79 provides the system of Embodiment 78, further comprising a fluid processing unit configured to process the composition exiting the annulus to generate a cleaned drilling fluid for recirculation through the wellbore.

Embodiment 80 provides the system of any one of Embodiments 77-79, further comprising a tubular disposed in a wellbore; a pump configured to pump the composition downhole.

Embodiment 81 provides a composition for treatment of a subterranean formation, the composition comprising:

a friction-reducing polymer comprising about Z¹ mol % of an ethylene repeating unit comprising a —C(O)NHR¹ group and comprising about N¹ mol % of an ethylene repeating unit comprising a —C(O)R² group, wherein
at each occurrence R¹ is independently a substituted or unsubstituted C₅-C₅₀ hydrocarbyl;
at each occurrence R² is independently selected from the group consisting of —NH₂ and —OR³, wherein at each occurrence R³ is independently selected from the group consisting of —R¹, —H, and a counterion; and
the repeating units are in block, alternate, or random configuration, Z¹ is about 0.001% to about 50%, N¹ is about 50% to about 99.999%, and Z¹+N¹ is about 100%.

Embodiment 82 provides the composition of Embodiment 81, wherein the composition further comprises at least one of an aqueous liquid, a downhole fluid, and a proppant.

Embodiment 83 provides a composition for treatment of a subterranean formation, the composition comprising:

a friction-reducing polymer has repeating units having the structure

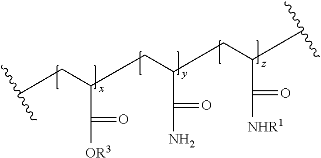

wherein
at each occurrence R¹ is independently C₅-C₅₀ alkyl,
at each occurrence R² is independently selected from the group consisting of —NH₂ and —OR³, wherein at each occurrence R³ is independently selected from the group consisting of —H and a counterion selected from the group consisting of Na⁺, K⁺, Li⁺, NH₄⁺, and Mg²⁺,
the repeating units are in a block, alternate, or random configuration, each repeating unit is independently in the orientation shown or in the opposite orientation, and
x is about 300 to about 500,000, y is about 1,000 to about 3,500,000, and z is about 100 to about 1,000,000.

Embodiment 84 provides a method of preparing a composition for treatment of a subterranean formation, the method comprising:

forming a composition comprising a friction-reducing polymer comprising about Z¹ mol % of an ethylene repeating unit comprising a —C(O)NHR¹ group and comprising about N¹ mol % of an ethylene repeating unit comprising a —C(O)R² group, wherein
at each occurrence R¹ is independently a substituted or unsubstituted C₅-C₅₀ hydrocarbyl,
at each occurrence R² is independently selected from the group consisting of —NH₂ and —OR³, wherein at each occurrence R³ is independently selected from the group consisting of —R¹, —H, and a counterion, and
the repeating units are in block, alternate, or random configuration, Z¹ is about 0.001% to about 50%, N¹ is about 50% to about 99.999%, and Z¹+N¹ is about 100%.

Embodiment 85 provides the composition, apparatus, method, or system of any one or any combination of Embodiments 1-84 optionally configured such that all elements or options recited are available to use or select from.

What is claimed is:

1. A method of treating a subterranean formation, the method comprising:
obtaining or providing an aqueous composition comprising a friction-reducing water-soluble polymer comprising about Z¹ mol % of an ethylene repeating unit comprising a —C(O)NHR¹ group and comprising about N¹ mol % of an ethylene repeating unit comprising a —C(O)R² group, wherein
at each occurrence R¹ is independently a substituted or unsubstituted C₅-C₅₀ hydrocarbyl,
at each occurrence R² is independently selected from the group consisting of —NH₂ and —OR³, wherein at each occurrence R³ is independently selected from the group consisting of —R¹, —H, and a counterion,
the repeating units are in block, alternate, or random configuration, Z¹ is about 0.001% to about 50%, N¹ is about 50% to about 99.999%, and Z¹+N¹ is about 100%; and
placing the composition in a subterranean formation downhole.

2. The method of claim 1, wherein the composition comprises an oil-external emulsion comprising the friction-reducing polymer in the internal phase and an oil or organic solvent in the external phase.

3. The method of claim 1, wherein the composition comprises an aqueous liquid or wherein a mixture includes the composition and the aqueous liquid.

4. The method of claim 3, wherein the method further comprises mixing an aqueous liquid and an oil-external emulsion comprising the friction-reducing polymer.

5. The method of claim 3, wherein the aqueous liquid comprises salt water having a total dissolved solids level of about 1,000 mg/L to about 250,000 mg/L.

6. The method of claim 1, wherein the friction-reducing polymer is sufficient such that, at a concentration of the friction-reducing polymer of about 0.64 wt % in water, at a shear rate of about 0.1 s⁻¹, at standard temperature and pressure, a viscosity of about 9,500 cP to about 100,000 cP is provided.

7. The method of claim 5, wherein the friction-reducing polymer is sufficient such that, at a concentration of the friction-reducing polymer of about 150 ppmw in the salt water, after about 25 minutes of pumping through a pipe having an inside diameter of about 0.5 inches at about 10 gal/min, at standard temperature and pressure, a friction reduction of about 57% to about 80% is provided, as compared to friction experienced under corresponding conditions by a corresponding solution not including the friction-reducing polymer.

8. The method of claim 5, wherein the friction-reducing polymer is sufficient such that, at a concentration of the friction-reducing polymer of about 150 ppmw in the salt water, after about 25 minutes of pumping through a pipe having an inside diameter of about 0.5 inches at about 10 gal/min, a friction reduction is provided, as compared to that experienced under corresponding conditions by a corresponding solution not including the friction-reducing polymer, that is about 1% to about 70% greater as compared to the friction reduction experienced by the salt water under corresponding conditions but having in place of the friction-reducing polymer a corresponding polymer having —C(O)NH₂ groups in place of the —C(O)NHR¹ groups.

9. The method of claim 1, wherein the placement of the composition in the subterranean formation comprises fracturing at least part of the subterranean formation to form at least one subterranean fracture.

10. The method of claim 1, wherein the composition further comprises a proppant, a resin-coated proppant, or a combination thereof.

11. The method of claim 1, wherein the friction-reducing polymer is about 0.001 wt % to about 50 wt % of the composition.

12. The method of claim 1, wherein the friction-reducing polymer is a terpolymer comprising about X¹ mol % of an ethylene repeating unit comprising a —C(O)OR³ group and comprising about Y¹ mol % of an ethylene repeating unit comprising a —C(O)NH₂ group, wherein the repeating units are in block, alternate, or random configuration, Z¹ is about 0.001% to about 25%, X¹ is about 5% to about 40%, Y¹ is about 40% to about 95%, and Z¹+X¹+Y¹ is about 100%

13. The method of claim 1, wherein the friction-reducing polymer comprises repeating units having the structure 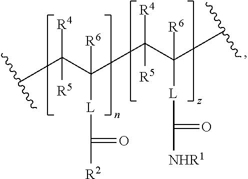
wherein
at each occurrence R⁴, R⁵, and R⁶ are independently selected from the group consisting of —H and a substituted or unsubstituted C₁-C₅ hydrocarbyl,
at each occurrence L is independently selected from the group consisting of a bond and a substituted or unsubstituted C₁-C₂₀ hydrocarbyl,
the repeating units are in a block, alternate, or random configuration, and each repeating unit is independently in the orientation shown or in the opposite orientation.

14. The method of claim 1, wherein the friction-reducing polymer comprises repeating units having the structure 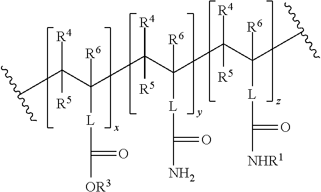
wherein
at each occurrence R⁴, R⁵, and R⁶ are independently selected from the group consisting of —H and a substituted or unsubstituted C₁-C₅ hydrocarbyl,
at each occurrence L is independently selected from the group consisting of a bond and a substituted or unsubstituted C₁-C₂₀ hydrocarbyl,
the repeating units are in a block, alternate, or random configuration, each repeating unit is independently in the orientation shown or in the opposite orientation, and x+y=n.

15. The method of claim 14, wherein x/(x+y+z) is about 5% to about 40%, and y/(x+y+z) is about 40% to about 95%.

16. The method of claim 1, wherein the friction-reducing polymer comprises repeating units having the structure 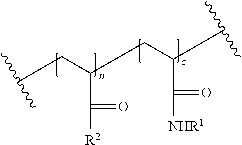
wherein
at each occurrence R¹ is independently C₅-C₅₀ alkyl,
at each occurrence R² is independently selected from the group consisting of —NH₂ and —OR³, wherein at each occurrence R³ is independently selected from the group consisting of —H and a counterion selected from the group consisting of Na⁺, K⁺, Li⁺, NH₄⁺, and Mg²⁺,
the repeating units are in a block, alternate, or random configuration, each repeating unit is independently in the orientation shown or in the opposite orientation, and
n is about 20,000 to about 2,000,000 and z is about 100 to about 1,000,000.

17. The method of claim 1, wherein the friction-reducing polymer comprises repeating units having the structure 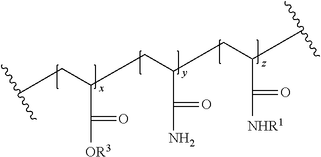
wherein
at each occurrence R¹ is independently C₅-C₅₀ alkyl,
at each occurrence R² is independently selected from the group consisting of —NH₂ and —OR³, wherein at each occurrence R³ is independently selected from the group consisting of —H and a counterion selected from the group consisting of Na⁺, K⁺, Li⁺, NH₄⁺, and Mg²⁺,
the repeating units are in a block, alternate, or random configuration, each repeating unit is independently in the orientation shown or in the opposite orientation, and
x is about 300 to about 500,000, y is about 1,000 to about 3,500,000, and z is about 100 to about 1,000,000.

18. A system for performing the method of claim 1, the system comprising:
a tubular disposed in a wellbore;
a pump configured to pump the composition downhole through the tubular and into the subterranean formation.

19. A method of treating a subterranean formation, the method comprising:
obtaining or providing a composition comprising a friction-reducing polymer comprises repeating units having the structure 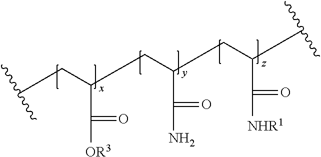
wherein
at each occurrence R¹ is independently C₅-C₅₀ alkyl;
at each occurrence R² is independently selected from the group consisting of —NH₂ and —OR³, wherein at each occurrence R³ is independently selected from the group consisting of —H and a counterion selected from the group consisting of Na⁺, K⁺, Li⁺, NH₄⁺, and Mg²⁺,
the repeating units are in a block, alternate, or random configuration, each repeating unit is independently in the orientation shown or in the opposite orientation, and
x is about 300 to about 500,000, y is about 1,000 to about 3,500,000, and z is about 100 to about 1,000,000; and
placing the composition in a subterranean formation.

20. A composition for treatment of a subterranean formation, the composition comprising:
a friction-reducing polymer comprising about Z¹ mol % of an ethylene repeating unit comprising a —C(O)NHR¹ group and comprising about N¹ mol % of an ethylene repeating unit comprising a —C(O)R² group, wherein
at each occurrence R¹ is independently a substituted or unsubstituted C₅-C₅₀ hydrocarbyl;
at each occurrence R² is independently selected from the group consisting of —NH₂ and —OR³, wherein at each occurrence R³ is independently selected from the group consisting of —R¹, —H, and a counterion; and
the repeating units are in block, alternate, or random configuration, Z¹ is about 0.001% to about 50%, N¹ is about 50% to about 99.999%, and Z¹+N¹ is about 100%.
